(19) United States
(12) Patent Application Publication
(10) Pub. No.: US 2010/0109537 A1
(43) Pub. Date: May 6, 2010

(54) LED LIGHTING CIRCUIT AND ILLUMINATING APPARATUS USING THE SAME

(75) Inventors: Hiroyuki Nishino, Hirakata (JP); Eiji Shiohama, Katano (JP)

Correspondence Address: GREENBLUM & BERNSTEIN, P.L.C., 1950 ROLAND CLARKE PLACE, RESTON, VA, 20191, US

(73) Assignee: PANASONIC ELECTRIC WORKS CO., LTD., Osaka (JP)

(21) Appl. No.: 12/447,123

(22) PCT Filed: Oct. 19, 2007
(86) PCT No.: PCT/JP2007/070429

§ 371 Date: Apr. 24, 2009

(30) Foreign Application Priority Data
Oct. 25, 2006 (JP) 2006-290076
Oct. 25, 2006 (JP) 2006-290077
Nov. 17, 2006 (JP) 2006-312104
Nov. 24, 2006 (JP) 2006-317430
Nov. 24, 2006 (JP) 2006-317752

(51) Int. Cl. H05B 39/00; H05B 37/02

(52) U.S. Cl. 315/185 R; 315/294

(57) ABSTRACT

Light outputs from many LEDs are uniformized and power consumption required for such uniformizing is suppressed, in an LED lighting circuit to be used for illuminating apparatus and the like. Currents flowing from a DD converter to an LED module are detected by a current detection resistor and compared with a reference voltage (Vref) from a reference voltage source by a comparison circuit. Corresponding to the comparison results, a control circuit controls the DD converter, and the currents flowing to the LED module are controlled to be constant currents at the same time. Furthermore, in LED load circuits configuring the LED module, control elements configuring a current mirror circuit are arranged in series, a corresponding control element is permitted to have a diode structure by having a circuit with the highest sum of the LED ON voltages as a reference, the flowing current values of the control elements of the remaining circuits are interlocked, and the LED load circuits are balanced.

### TECHNICAL FIELD

The present invention relates to an LED lighting circuit and an illuminating apparatus using the LED lighting circuit, and more particularly, to a technique for uniformizing currents of a plurality of LEDs arranged in parallel.

### BACKGROUND ART

When many LEDs (light-emitting diodes) are used to obtain required light output as in the case where the LEDs are used for the illuminating apparatus, or even when a chip is fragmented to obtain the same light output because LEDs with low currents have high efficiency, an exorbitant power supply voltage is required to connect the plurality of LEDs in series and light up the LEDs. On the other hand, when the many LEDs are connected parallel to each other and lit up, an exorbitantly high current is required. Therefore, an appropriate serial/parallel configuration that fits the application is actually adopted. However, in the case of blue LEDs, an ON voltage Vf thereof is on the order of 3 to 3.5 V, has a great variation and combining the LEDs in series or parallel results in a problem that differences are likely to occur in split ratio among serial circuits arranged parallel to each other, that is, differences are likely to occur in brightness among the serial circuits.

More specifically, light outputs from the LEDs are said to depend on flowing current values, and from this standpoint, the flowing current values in the serial configuration remain the same even if there are variations in ON voltages Vf of the individual LEDs, and so the variations in light outputs of the individual LEDs are also small. In contrast, in the case of a parallel configuration, when the sum of LED ON voltages Vf in the series configuration differs, currents flowing to the series circuits from a collective output of the lighting circuit (power supply circuit) are concentrated on a circuit with a low ON voltage Vf and the light outputs vary a great deal from one series circuit to another.

FIG. 29 is a block diagram showing a configuration of a typical LED lighting circuit 1 of a prior art. This prior art is disclosed in Patent Document 1. In this LED lighting circuit 1, an LED module 2 is constructed of LED load circuits u1 to u3 connected in parallel, each LED load circuit being made up of many serially connected LED loads. The LED module 2 is given a DC voltage VDC resulting from converting a voltage Vac from a commercial power supply 3 to DC through a noise cut capacitor c1 and a rectification bridge 4 and converting the DC to a voltage through a DC-DC converter 5.

The DC-DC converter 5 is constructed of a voltage boosting chopper circuit provided with a switching element q0 that switches the DC output voltage of the rectification bridge 4, a choke coil 1 that stores/discharges the excitation energy resulting from the switching, a diode d and a smoothing capacitor c2 that rectify and smooth the output current from the choke coil 1, a resistor r1 for converting the current flowing through the switching element q0 to a voltage and a control circuit 6 that controls the switching of the switching element q0.

On the other hand, constant current circuits q1 to q3 for equalizing values of currents flowing through the LED load circuits u1 to u3 are inserted in series respectively. The applied voltages (load voltages) of the constant current circuits q1 to q3 are compared with a reference voltage Vref from a reference voltage source 8 by a comparison circuit 7, the comparison results are given to the control circuit 6 and the control circuit 6 controls the constant voltage output of the DC-DC converter 5 so that the applied voltages of the respective constant current circuits q1 to q3 become smaller than the sum of the ON voltages Vf of the series LEDs. This suppresses losses at the respective constant current circuits q1 to q3. However, this prior art has a problem that the overall light output level varies as the variations in the LED ON voltages Vf increase and losses at the constant current circuits q1 to q3 also increase.

FIG. 30 is a block diagram showing a configuration of an LED lighting circuit 11 of another prior art. This prior art is disclosed in Patent Document 2. This LED lighting circuit 11 is configured to convert a total value of currents flowing to the respective LED load circuits u1 to u3 to a voltage and detect the voltage by a resistor r2, compare the voltage with a reference voltage Vref by a comparator 17 and control a DC-DC converter 15 through a PWM control circuit 16 so that the comparison result is kept to a constant value. The DC-DC converter 15 is constructed of a one-transistor flyback converter that switches a voltage Vdc from a DC power supply 13 by a switching element q0 and gives the voltage Vdc to the primary side of a transformer t, gives a DC voltage VDC resulting from rectifying/smoothing the secondary side output by a rectification smoothing circuit 14 to the respective LED load circuits u1 to u3 and thereby insulates the power supply side from the load side. In this LED lighting circuit 11, constant current circuits d1 to d3 are also connected in series to the respective LED load circuits u1 to u3 respectively.

FIG. 31 is an electric circuit diagram showing a specific example of the constant current circuit d1 to d3. This constant current circuit d1 to d3 is configured by including a transistor q11 and a resistor r11 connected in series to the LED load circuit u1 to u3, a resistor r12 that connects the collector and the base of the transistor q11 and a Zener diode dz inserted between the base and the emitter of the transistor q11. The collector current of the transistor q11 is kept to a constant current under a condition that the sum of a voltage drop of the resistor r11 and a base-emitter voltage Vbe of the transistor q11 substantially matches the Zener voltage of the Zener diode dz.

Thus, the currents of the respective LED load circuits u1 to u3 are individually kept to a constant current and the collective output current of the DC-DC converter 15 is also controlled to a constant current and it is thereby possible to significantly suppress variations in the light outputs due to variations in the LED ON voltages Vf. However, there is a problem that this constant current circuit d1 to d3 has greater loss than the simple constant current circuit q1 to q3 made up of an FET source-follower circuit.

Thus, the present inventor has proposed an LED lighting circuit 21 as shown in FIG. 32 in Patent Document 3. According to this prior art, transistors q21 and q22, and resistors r21 and r22 are connected in series to LED load circuits u1 and u2 respectively and a transistor q20 configuring a current mirror circuit with the transistors q21 and q22 is inserted between the terminals of the DC power supply 23 via resistors r23, r24, r20, and the like. A reference current determined by the voltage VDC from the DC power supply 23 and resistors r23, r24 and r20 flows to the transistor q20, the currents flowing through the transistors q21 and q22 are balanced with the reference current and variations in the light outputs are thereby suppressed. The resistor r24 is short-circuited by a bypass switch sw provided parallel to one resistor (r24 in this example) so as to increase the reference current and also increase the light output.

However, although the above described method using a mirror circuit is convenient for balancing currents between the LED load circuits u1 and u2, the method also involves a problem that the reference current varies due to a variation of the power supply voltage VDC and losses are produced at the resistors r23, r24, r20 that create the reference current and the transistor q20.

### Patent Document 1: Japanese Patent Laid-Open No. 2002-8409

### Patent Document 2: Japanese Patent Laid-Open No. 2004-319583

### Patent Document 3: Japanese Patent Laid-Open No. 2004-39290

### DISCLOSURE OF THE INVENTION

It is an object of the present invention to provide an LED lighting circuit capable of uniformizing light outputs of many LEDs with low loss and an illuminating apparatus using the LED lighting circuit.

The LED lighting circuit of the present invention provides control elements configuring a current mirror circuit in series to a plurality of LED circuits arranged parallel to each other, uses a circuit having the highest voltage drop by LED currents including the respective LED ON voltages as a reference, allows the control element in the circuit to have a diode structure and causes flowing current values of the control elements of the remaining circuits to be interlocked through control terminals of the control element. Such a configuration allows the current mirror circuit to uniformly control current balance between the parallel LEDs, and can thereby uniformize light outputs from many LEDs. Furthermore, since a circuit having the highest voltage drop by the LED currents including the ON voltages is used as the circuit that creates a reference current for the current mirror circuit, such a configuration does not require the circuit that creates only a reference current and can eliminate circuit loss accordingly.

### BRIEF DESCRIPTION OF THE DRAWINGS

FIG. 1 is a block diagram showing a configuration of an LED lighting circuit according to Embodiment 1 based on a first viewpoint of the present invention;

FIG. 2 is a block diagram showing a configuration of another mode of the DC power supply in the LED lighting circuit according to Embodiment 1 based on the first viewpoint of the present invention;

FIG. 3 is a block diagram showing a configuration of a further mode of the DC power supply in the LED lighting circuit according to Embodiment 1 based on the first viewpoint of the present invention;

FIG. 4 is a block diagram showing a configuration of a still further mode of the DC power supply in the LED lighting circuit according to Embodiment 1 based on the first viewpoint of the present invention;

FIG. 5 is a block diagram showing a configuration of an LED lighting circuit according to Embodiment 2 based on the first viewpoint of the present invention;

FIG. 6 is a block diagram showing a configuration of an LED lighting circuit according to Embodiment 1 based on a second viewpoint of the present invention;

FIG. 7 shows a state when wire breakage has occurred in one LED;

FIG. 8 is a block diagram showing a configuration of another mode of the DC power supply in the LED lighting circuit according to Embodiment 1 based on the second viewpoint of the present invention;

FIG. 9 is a block diagram showing a configuration of a further mode of the DC power supply in the LED lighting circuit according to Embodiment 1 based on the second viewpoint of the present invention;

FIG. 10 is a block diagram showing a configuration of a further mode of the DC power supply in the LED lighting circuit according to Embodiment 1 based on the second viewpoint of the present invention;

FIG. 11 is a block diagram showing a configuration of an LED lighting circuit according to Embodiment 1 based on a third viewpoint of the present invention;

FIGS. 12A to C show examples of the impedance element in the lighting circuit shown in FIG. 11;

FIG. 13 is a block diagram showing another configuration example of the LED lighting circuit according to Embodiment 1 based on the third viewpoint of the present invention;

FIG. 14 is a block diagram showing a configuration of an LED lighting circuit according to Embodiment 2 based on the third viewpoint of the present invention;

FIG. 15 is a block diagram showing a configuration of the Vf detection circuit and the switching control circuit in the lighting circuit shown in FIG. 11;

FIG. 16 is a block diagram showing a configuration of an LED lighting circuit according to Embodiment 3 based on the third viewpoint of the present invention;

FIG. 17 is a block diagram showing a configuration of an LED lighting circuit according to Embodiment 4 based on the third viewpoint of the present invention;

FIG. 18 is a block diagram showing a configuration of an LED lighting circuit according to Embodiment 1 based on a fourth viewpoint of the present invention;

FIGS. 19A and B show configuration examples of the splitting circuit in the lighting circuit shown in FIG. 18;

FIG. 20 is a block diagram showing a configuration of an LED lighting circuit according to Embodiment 2 based on the fourth viewpoint of the present invention;

FIG. 21 is a block diagram showing a configuration of an LED lighting circuit according to Embodiment 3 based on the fourth viewpoint of the present invention;

FIG. 22 is a block diagram showing a configuration of an LED lighting circuit according to Embodiment 1 based on a fifth viewpoint of the present invention;

FIG. 23 is a block diagram showing another example of the wire breakage detection circuit in the LED lighting circuit shown in FIG. 22;

FIG. 24 is a block diagram showing a further example of the wire breakage detection circuit in the LED lighting circuit shown in FIG. 22;

FIG. 25 is a block diagram showing a configuration of the LED lighting circuit according to Embodiment 2 based on the fifth viewpoint of the present invention;

FIG. 26 is a block diagram showing a configuration of an LED lighting circuit according to Embodiment 3 based on the fifth viewpoint of the present invention;

FIG. 27 is a block diagram showing a configuration of an LED lighting circuit according to Embodiment 4 based on the fifth viewpoint of the present invention;

FIG. 28 is a block diagram showing another configuration of the LED lighting circuit according to Embodiment 4 based on the fifth viewpoint of the present invention;

FIG. 29 is a block diagram showing a configuration of an LED lighting circuit according to a typical prior art;

FIG. 30 is a block diagram showing a configuration of an LED lighting circuit according to another prior art;

FIG. 31 is an electric circuit diagram showing a specific example of the constant current circuit in the LED lighting circuit shown in FIG. 30; and

FIG. 32 is a block diagram showing a configuration of an LED lighting circuit according to a further prior art.

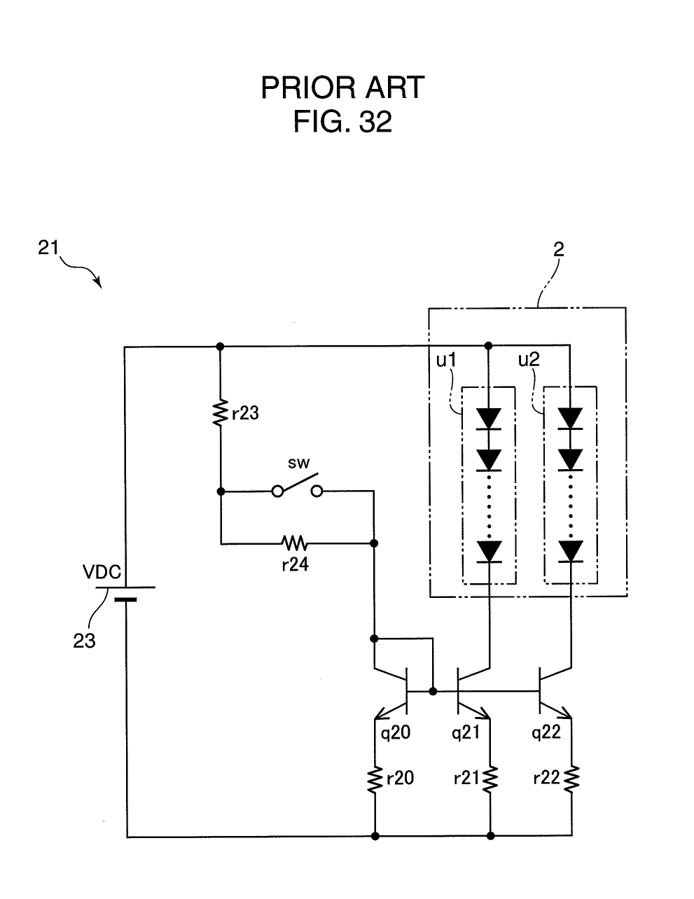

### BEST MODE FOR CARRYING OUT THE INVENTION

Hereinafter, an embodiment of the present invention will be explained with reference to the accompanying drawings. Configurations assigned the same reference numerals among the drawings indicate the same configurations and explanations thereof will be omitted

### Embodiment 1 Based on First Viewpoint

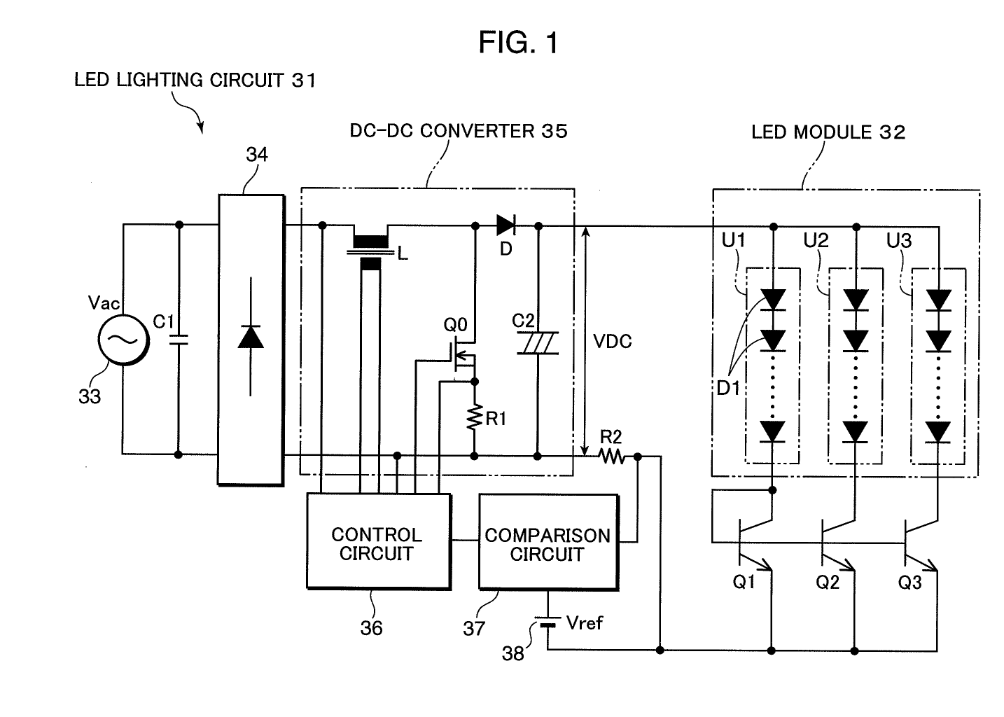

FIG. 1 is a block diagram showing a configuration of an LED lighting circuit 31 according to Embodiment 1 based on a first viewpoint of the present invention. In this LED lighting circuit 1, an LED module 32 is configured with three LED load circuits U1 to U3 connected in parallel, each LED load circuit being made up of many serially connected LEDs D1. The number of series LED loads in each LED load circuit U1 to U3 is arbitrary and each LED load circuit may also be constructed of a single LED.

Each LED load circuit U1 to U3 is configured such that the LEDs D1 are mounted on and bonded to a common heat sink and a fluorescent substance for wavelength conversion and a light diffusion lens and the like are also mounted. The LED module 32 and LED lighting circuit 31 are used as an illuminating apparatus, and emit blue or ultraviolet light as the LED load, convert, in wavelength, the light from the LED load using the fluorescent substance and emit the light as white light. The number of parallel circuits of the LED load circuits U1 to U3 is also arbitrary and a technique for obtaining white light by combining light emitted in three primary colors RGB, for example, is also arbitrary.

A DC voltage VDC resulting from converting a voltage Vac from a commercial power supply 33 to DC through a noise cut capacitor C1 and a rectification bridge 34 and converting the DC to a voltage via a DC-DC converter 35 is added to the LED module 32. The DC-DC converter 35 is constructed of a voltage boosting chopper circuit configured by including a switching element Q0 that switches the DC output voltage of the rectification bridge 34, a choke coil L that stores/discharges excitation energy through the switching, a diode D and a smoothing capacitor C2 that rectify and smooth the output current from the choke coil L, a resistor R1 that converts a current flowing through the switching element Q0 to a voltage for detection and a control circuit 36 that controls the switching of the switching element Q0.

The current that flows from the DC-DC converter 35, which is a DC power supply, to the LED module 32 is converted to a voltage value by a current detection resistor R2, compared with a reference voltage Vref from a reference voltage source 38 by a comparison circuit 37 and the comparison result is fed back to the control circuit 36. The control circuit 36 controls the switching frequency and duty of the switching element Q0 in response to the detection results of the resistors R1 and R2. Constant voltage control over the voltage VDC and constant current control over the current that flows to the LED module 32 are performed in this way.

What should be noted is that according to the present embodiment, in the respective LED load circuits U1 to U3, control elements Q1 to Q3 configuring a current mirror circuit are arranged in series to equalize values of currents flowing through the LED load circuits U1 to U3, and using a circuit (U1 in FIG. 1) with the highest voltage drop by the LED currents including the sum of the LED ON voltages Vf in the corresponding LED load circuits U1 to U3 in the control elements Q1 to Q3 as a reference, the control element in the circuit (Q1 in the example of FIG. 1) is to have a diode structure, the flowing current values of the control elements (Q2 and Q3 in the example of FIG. 1) of the remaining circuits (U2 and U3 in the example of FIG. 1) are interlocked through the control terminals and the LED load circuits U1 to U3 are thereby balanced.

To be more specific, when the control elements are transistors as shown in FIG. 1, the base and collector, which are the control terminals, are short-circuited for the control element Q1 and the bases of the control elements Q1 to Q3 are commonly connected. On the other hand, when the control terminals are MOS type transistors, the gate and drain, which are the control terminals, are short-circuited for the control element Q1 and the gates of the control elements Q1 to Q3 are commonly connected.

Therefore, the currents flowing from the DC-DC converter 35 to the respective LED load circuits U1 to U3 are controlled through collective constant current control based on the detection result of the resistor R2 so that the sum of the flowing current values is kept constant and the current balance between the respective LED load circuits U1 to U3 is uniformly controlled through the current mirror circuit, and it is thereby possible to uniformize light outputs from the many LEDs D1. Furthermore, since the LED load circuit (U1 in the example of FIG. 1) having the highest voltage drop by the LED currents including the sum of the ON voltage Vf is used for the circuit (Q1 in the example of FIG. 1) that creates a reference current of the current mirror circuit, the circuit that creates only a reference current is not necessary and circuit loss can be eliminated accordingly. Furthermore, one of the control elements Q1 to Q3 such as transistors is to have a diode structure and is only configured into a mirror circuit, and therefore the circuit can be realized in a low-cost configuration.

For example, when the number of LED load circuits is assumed to be three; U1 to U3, each LED load circuit U1 to U3 is constructed of five LEDs D1 and the variation of the ON voltage Vf is assumed to be ±5%, if only collective constant current control is performed based on the detection result of the resistor R2, that is, when the control elements Q1 to Q3 are not provided, the current variation between the LED load circuits U1 to U3 is 17.5 to 22.71 mA (current value of the collective constant current control is 60 mA), whereas when the control elements Q1 to Q3 are provided and other control elements Q2 and Q3 are allowed to perform mirror operation using the control element Q1 corresponding to the LED load circuit U1 having the maximum sum of ON voltages Vf as a reference, the current variation can be suppressed to 20.0 to 20.1 mA. Similarly, when a variation in the ON voltages Vf is assumed to be ±10%, the current variation can be suppressed to 15.2 to 25.8 mA only through collective constant current control and 20.0 to 20.1 mA by allowing the control elements Q2 and Q3 to perform mirror operation.

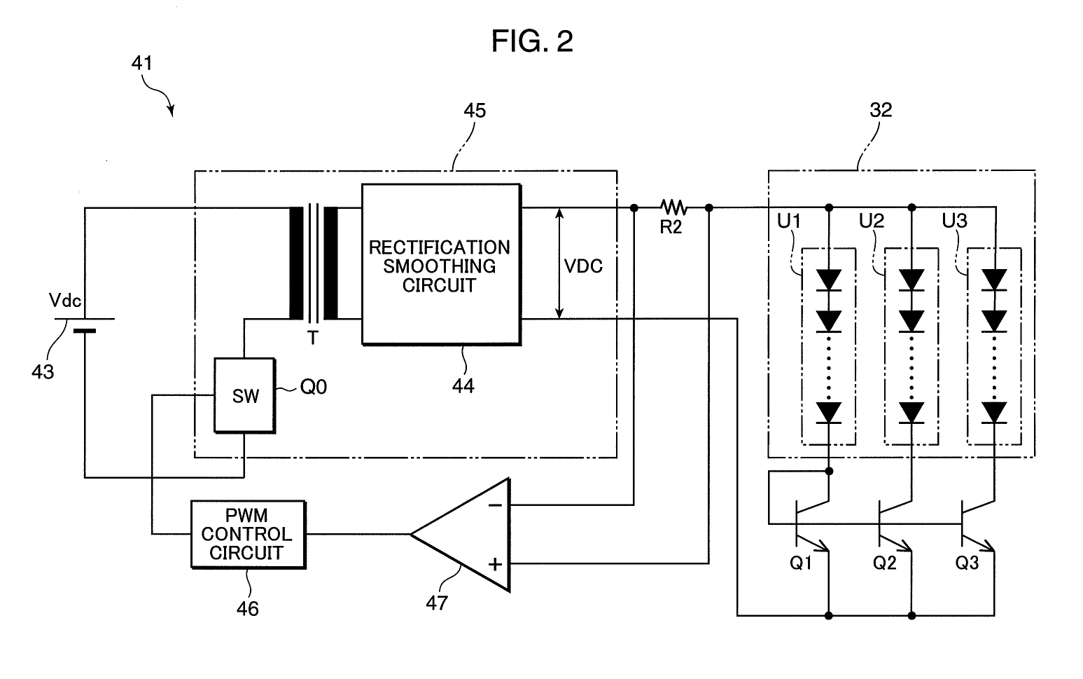

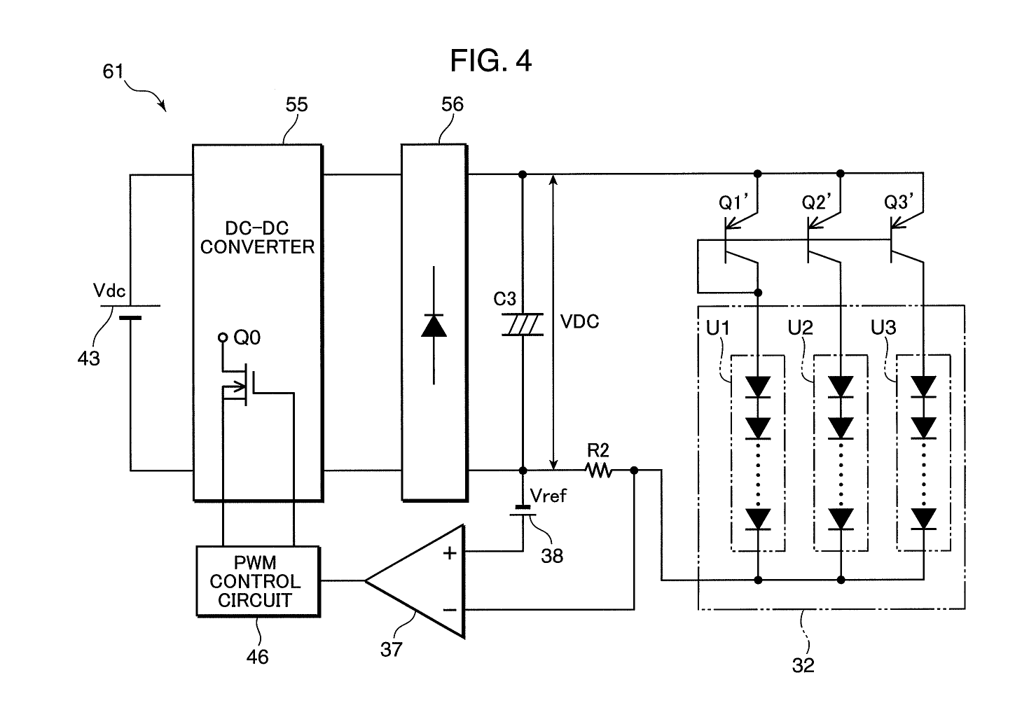

FIG. 2 to FIG. 4 are block diagrams showing configurations of LED lighting circuits 41, 51 and 61 with DC power supplies in different configurations. In the configurations in FIG. 2 to FIG. 4, configurations similar or corresponding to those shown in aforementioned FIG. 1 are assigned the same reference numerals and explanations thereof will be omitted. In the configurations in FIG. 2 to FIG. 4, the configuration of the LED module 32 made up of LED load circuits U1 to U3 is the same. However, while the control elements Q1 to Q3 connected in series to the LED load circuits U1 to U3 in FIG. 1 to FIG. 3 are N-type transistors, control elements Q1′ to Q3′ in FIG. 4 are P-type transistors. However, in the example of this FIG. 4, the U1 is assumed to be the circuit having the maximum sum of LED ON voltages Vf out of the respective LED load circuits U1 to U3, and the corresponding control element Q1′ has a diode structure and the values of currents flowing through the remaining circuits U2 and U3 are interlocked through the control elements Q2′ and Q3′.

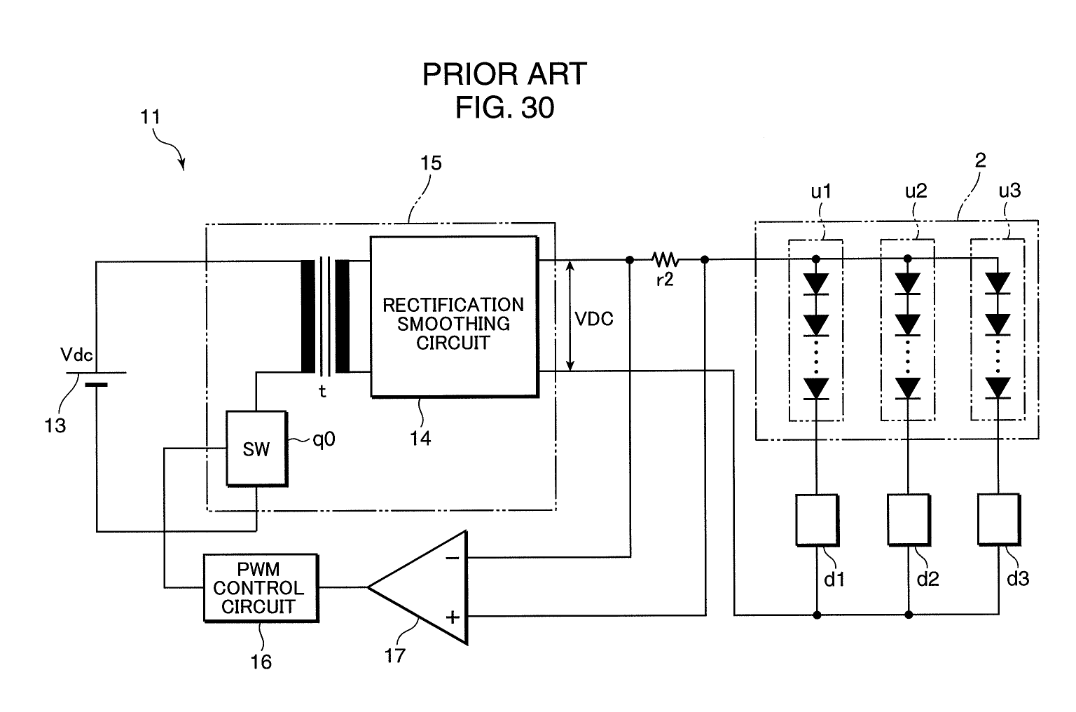

The LED lighting circuit 41 shown in FIG. 2 is configured such that the total value of currents flowing to the respective LED load circuits U1 to U3 is converted to a voltage and detected by a resistor R2, the voltage is compared with a reference voltage Vref by a comparator 47 and a DC-DC converter 45 is controlled via a PWM control circuit 46 so that the comparison result is kept to a constant value. The DC-DC converter 45 is constructed of a one-transistor flyback converter that switches a voltage Vdc from a DC power supply 43 by a switching element Q0, given to the primary side of a transformer T, a DC voltage VDC resulting from rectifying/smoothing the secondary side output through a rectification smoothing circuit 44 is given to the respective LED load circuits U1 to U3 so as to insulate the power supply side from the load side. This LED lighting circuit 41 is similar to the LED lighting circuit 11 shown in the aforementioned conventional example in FIG. 30.

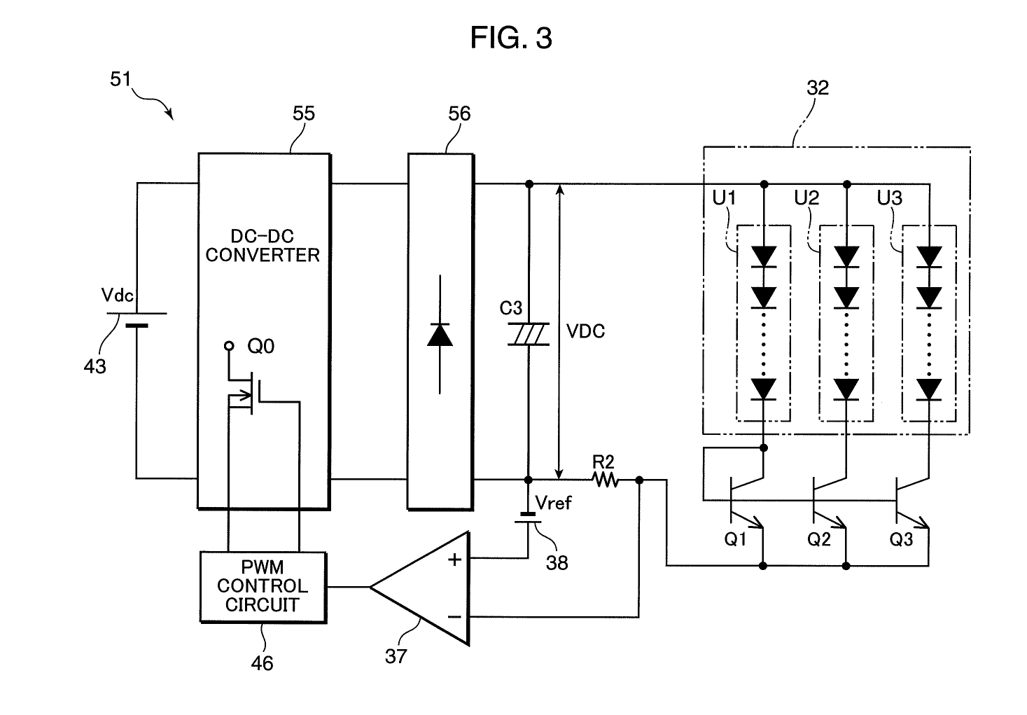

In an LED lighting circuit 51 or 61 shown in FIG. 3 or FIG. 4, a voltage Vdc from a DC power supply 43 is boosted or lowered by a DC-DC converter 55, rectified by a full-wave or half-wave rectifier 56, smoothed by a smoothing capacitor C3 and the DC voltage VDC is then given to the LED module 32. The total value of currents flowing to the respective LED load circuits U1 to U3 is converted to a voltage and detected by the resistor R2, the voltage is compared with a reference voltage Vref from the reference voltage source 38 by the comparator 37 and the PWM control circuit 6 controls the DC-DC converter 55 so that the comparison result is kept to a constant value.

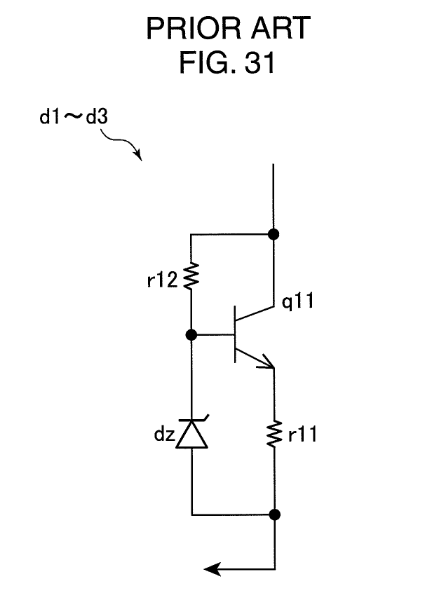

Here, Table 1 shows details of losses at the control elements Q1 to Q3 in the case where the DC-DC converter 35, which is a DC power supply, performs only constant current control based on the detection result of the resistor R2 using the current mirror circuit according to the present embodiment and in the case where only constant voltage control over the voltage VDC is performed as shown in the conventional example in FIG. 30. Furthermore, Table 1 also shows details of losses in the case where the constant current circuits d1 to d3 shown in conventional examples in FIG. 30 and FIG. 31 are used and when constant current control is performed and when constant voltage control is performed. Suppose conditions of test calculations are such that the current flowing through the LED load circuit U1 to U3, that is, rated current of the LEDs D1 is 20 mA, ON voltage Vf of the LED D1 is 3.2 V, and the variation thereof is ±10%, and hfe of the control element (transistor) Q1 to Q3 is 100.

TABLE 1
TABLE 1

| | CONSTANT CURRENT CONTROL | |
|---|---|---|
| | NO Vf VARIATION | MAXIMUM Vf VARIATION |
| C | ⋄CONSTANT CURRENT CONTROL | ⋄CONSTANT CURRENT CONTROL |
| M | VALUE: 60 mA | VALUE: 60 mA |
| | ⋄LOSS OF TRANSISTORS Q1 TO Q3 | ⋄TOTAL Vf . . . REFERENCE CIRCUIT 17.6 v |

| | |
|---|---|
| •Ic = 20 mA | OTHER CIRCUIT 14.4 v |

| | •Ib = 0.2 mA | POTENTIAL DIFFERENCE 3.2 v |
|---|---|---|
| | •Vbe ≈ 0.6 V | ⋄P_{Q1} ≈ 20 mA × 0.6 v = 12 mW |
| | ∴P_{Q1~Q3} = 20 mA × 0.6 = 12 mW × 3 | ⋄^{p}_{Q2~Q3} ≈ 20 mA × (3.2 + 0.6)ᵥ = 76 mW × 2 |
| | TOTAL LOSS: 36 mW | TOTAL LOSS: 164 mW |
| CONSTANT | ⋄CONSTANT CURRENT CONTROL | ⋄CONSTANT CURRENT CONTROL |
| CURRENT | VALUE: 60 mA | VALUE: 60 mA |
| CIRCUIT | ⋄CONSTANT DESIGN | ⋄SAME AS LEFT |
| | •RESISTOR r11 . . . 200 Ω | TOTAL LOSS: 368 mW |
| | •dz . . . 2.4 V (0.1 mA) | |
| | •RESISTOR r12 = 5 kΩ | |
| | ⋄LOSS CALCULATION | |
| | •Pᵣ₁₁ ≈ (20 mA)² × 200 = 80 mW × 3 | |
| | •Pᵣ₁₂ ≈ (0.3 mA)² × 5k = 0.45 mW × 3 | |
| | •P_{dz} = 2.4 V × 0.1 mA = 0.24 mW × 3 | |
| | •P_{q11} ≈ 20 mA × (0.3 m × 5k + 0.6 v) = 42 mW × 3 | |
| | TOTAL LOSS: 368 mW | |

CONSTANT VOLTAGE CONTROL

| | NO Vf VARIATION | MAXIMUM Vf VARIATION |
|---|---|---|
| C | ⋄CONSTANT VOLTAGE CONTROL | ⋄CONSTANT VOLTAGE CONTROL |
| M | VALUE: 19 V | VALUE: 19 V |

| | |
|---|---|
| (SERIES 40 Ω ADDED FOR STABILITY | (SERIES 40 Ω ADDED FOR STABILITY |
| OF OPERATION) | OF OPERATION) |
| ⋄P_{Q1~Q3} = 20 mA × 0.6 = | ⋄TOTAL Vf . . . REFERENCE CIRCUIT 17.6 v |

| | |
|---|---|
| 12 mW × 3 | OTHER CIRCUIT 14.4 v |

| | ⋄LOSS OF ADDITIONAL RESISTOR 40 Ω | POTENTIAL DIFFERENCE 3.2 v |
|---|---|---|
| | P_{R1~R3} = (20 mA)² × 40 Ω = | ⋄ P_{Q1} ≈ 20 mA × 0.6 V = |
| | 16 mW × 3 | 12 mW |
| | TOTAL LOSS: 84 mW | ⋄ P_{Q2~Q3} ≈ 20 mA × 3.8 v = |
| | | 76 mW × 2 |
| | | ⋄LOSS OF ADDITIONAL RESISTOR 40 Ω |
| | | P_{R1~R3} ≈ (20 mA)² × 40 Ω = |
| | | 16 mW × 3 |
| | | R = (19 − 17.6 − 0.6) v ÷ 20 mA = |
| | | 40 Ω |
| | | TOTAL LOSS: 21.2 mW |
| CONSTANT | ⋄CONSTANT VOLTAGE CONTROL | ⋄CONSTANT VOLTAGE CONTROL |
| CURRENT | VALUE: 23.7 V | VALUE: 23.7 V |
| CIRCUIT | ⋄LOSS CALCULATION | ⋄CONSTANT VOLTAGE SET VALUE |

| | |
|---|---|
| •ΣVf = 3.2 × 5 = 16 v | •ΣVf: 17.6 v(max) |

| | |
|---|---|
| • CONSTANT CURRENT CIRCUIT | 14.4 v(min) |

| | |
|---|---|
| VOLTAGE DROP = 23.7 − 16 = | •Vf = 17.6 v(max) |
| 7.7 V | V_{R} = 20 mA × 200 Ω = 4 v |
| •LED CURRENT 20 mA | V_{Q} = 2.1 v |
| ∴ 7.7 v × 20 mA = 154 mW × 3 | ∴CONSTANT VOLTAGE VALUE 23.7 v |
| TOTAL LOSS: 462 mW | ⋄LOSS CALCULATION |

```
  •ΣVf = 14.4 v(min)
  •CONSTANT CURRENT CIRCUIT
    VOLTAGE DROP =
    23.7 − 14.4 = 9.3 v
  •LED CURRENT 20 mA
  ∴9.3 v × 20 mA = 186 mW × 3
  TOTAL LOSS: 558 mW
```

As is apparent from Table 1, according to the current balance control using the current mirror circuit of the present embodiment, loss is smaller when there is no variation in the ON voltage Vf, but it is understandable that constant current control produces less loss than constant voltage control regardless of the presence/absence of a variation in the ON voltage Vf. On the other hand, with the current balance control using the constant current circuits d1 to d3 shown in FIG. 30 and FIG. 31 in the aforementioned conventional examples, constant current control also produces less loss than constant voltage control regardless of the presence/absence of a variation in the ON voltage Vf, but since the total amount of current is limited in constant current control, it is understandable that loss is the same irrespective of whether or not there is a variation in the ON voltage Vf. Therefore, constant current control is preferable for current balance control by the current mirror circuit of the present embodiment and it is understandable that loss can be drastically reduced in securing the current balance under both conditions compared to the case where the constant current circuits d1 to d3 are used.

In the above explanations, the emitter area ratios of the control elements (transistors) Q1 to Q3, that is, the rated currents of the LEDs D1 in the LED load circuits U1 to U3 are the same, but the emitter area ratios may also be configured to be different from each other, and in that case, the control elements Q1 to Q3 perform control so as to maintain the different set current ratios. Furthermore, an organic EL (organic LED) is also applicable to the LEDs D1 of the present invention.

### Embodiment 2 Based on First Viewpoint

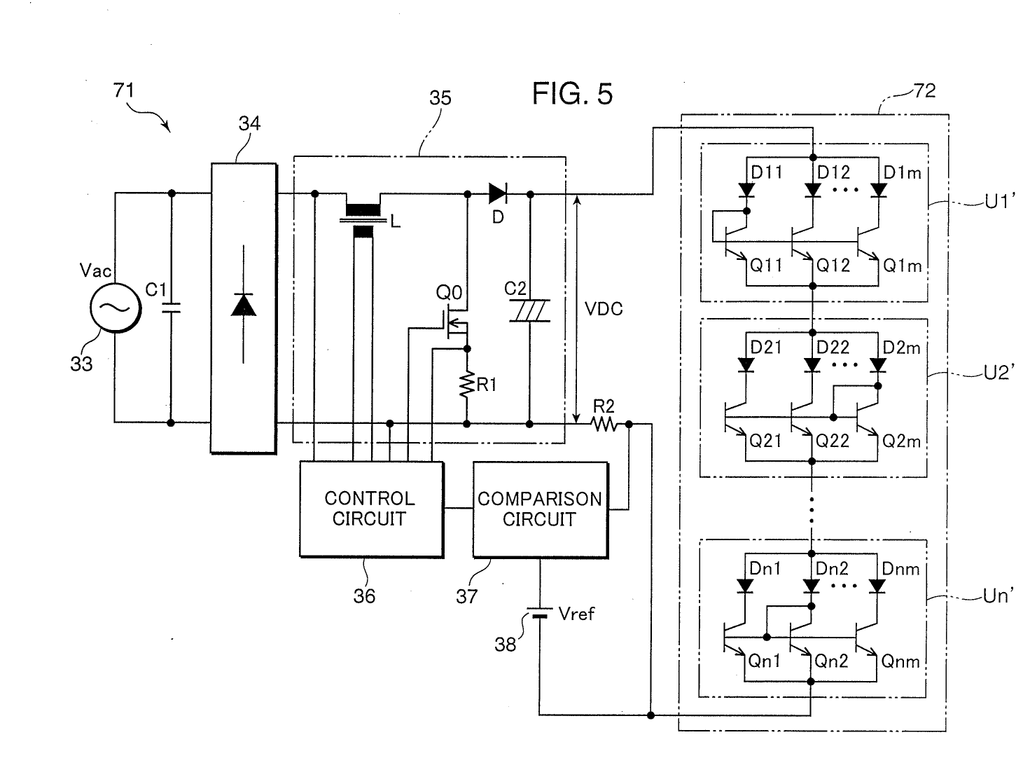

FIG. 5 is a block diagram showing a configuration of an LED lighting circuit 71 according to Embodiment 2 based on the first viewpoint of the present invention. In the LED lighting circuit 71, parts similar and corresponding to those of the aforementioned LED lighting circuit 31 will be assigned the same reference numerals and explanations thereof will be omitted. What should be noted is that in the LED lighting circuit 71, an LED module 72 is constructed of n LED load circuits U1′, U2′, . . . , Un′ connected in series and the respective LED load circuits U1′, U2′, . . . , Un′ are configured by including a plurality of LEDs D11, D12, . . . , D1m; D21, D22, . . . , D2m; . . . ; Dn1, Dn2, Dnm arranged parallel to each other and control elements Q11, Q12, . . . , Q1m; Q21, Q22, Q2m; . . . ; Qn1, Qn2, Qnm connected in series thereto and configuring current mirror circuits.

Using the LEDs (D11, D2m, . . . , Dn2 in FIG. 5) with the highest ON voltages Vf in the respective LED load circuits U1′ to Un′ as a reference, the control elements (Q11, Q2m, . . . , Qn2 in FIG. 5) corresponding to the LEDs D11, D2m, . . . , Dn2 are to have a diode structure and the flowing current values of the control elements of the remaining LEDs D12, . . . , D1m; D21, . . . , D2m−1; . . . ; Dn1, Dn3, . . . , Dnm in the same LED load circuits U1′ to Un′ are interlocked through the control terminals.

Such a configuration also allows light outputs from many LEDs D11 to Dnm to be uniformized. Furthermore, since the LEDs (D11, D2m, . . . , Dn2 in the example of FIG. 5) with the highest ON voltages Vf are used for the circuits (Q11, Q2m, . . . , Qn2 in the example of FIG. 5) for creating a reference current of the current mirror circuit are used, a circuit to create only a reference current is not necessary and circuit loss can be eliminated accordingly.

### Summary of First Viewpoint

As described above, the LED lighting circuit based on the first viewpoint of the present invention is an LED lighting circuit that causes a current to flow from a DC power supply to an LED module made up of a plurality of LEDs arranged parallel to each other, including control elements each of which being arranged in series to each of the parallel LED circuits configuring a current mirror circuit, in which a circuit with the highest voltage drop by LED currents including ON voltages of the LEDs is used as a reference, the control element in the circuit is to have a diode structure and the flowing current values of the control elements of the remaining circuits are interlocked through control terminals of the control elements.

Furthermore, the LED lighting circuit based on the first viewpoint of the present invention is an LED lighting circuit that causes a current to flow from a DC power supply to an LED module made up of a plurality of LED load circuits arranged parallel to each other, each LED load circuit being made up of one or a plurality of serially connected LEDs, preferably including control elements arranged in series to the LED load circuits configuring a current mirror circuit, in which a circuit with the highest voltage drop by LED currents including the sum of the LED ON voltages in the LED load circuits is used as a reference, the control element in the circuit is to have a diode structure and the flowing current values of the control elements of the remaining circuits are interlocked through control terminals of the control elements.

According to the above described configuration, in an LED lighting circuit to be used for an illuminating apparatus and the like, when a current is caused to flow from a DC power supply to an LED module with one or a plurality of LED load circuits made up of serially connected LEDs arranged parallel to each other, including control elements arranged in series to the LED load circuits configuring a current mirror circuit, in which a circuit with the highest voltage drop by the LED currents including the sum of the LED ON voltages in the LED load circuits is used as a reference, the control elements in the circuit is to have a diode structure and the flowing current values of the control elements of the remaining circuits are interlocked through control terminals of the control elements and the LED load circuits are thereby balanced. To be more specific, when the control elements are transistors, the base and collector, which are control terminals, are short-circuited and the bases are connected commonly. On the other hand, when the control elements are MOS type transistors, the gate and drain, which are control terminals, are short-circuited and the gates are connected commonly.

Therefore, since the current balance among the LED load circuits is uniformly controlled by the current mirror circuit, light outputs from many LEDs can be uniformized. Furthermore, since the LED load circuit with the highest sum of the ON voltages Vf is used for the circuit for creating the reference current of the current mirror circuit, a circuit to create only a reference current is not necessary and circuit losses can be reduced accordingly.

Furthermore, the LED lighting circuit based on the first viewpoint of the present invention is an LED lighting circuit that causes a current to flow from a DC power supply to an LED module made up of a plurality of LEDs, in which the LED module is preferably made up of a plurality of LED load circuits connected in series, each LED load circuit being made up of a plurality of LEDs connected parallel to each other and the LEDs are provided with control elements configuring a current mirror circuit arranged in series, and an LED with the highest ON voltage in the LED load circuits is used as a reference, the control element corresponding to the LED is to have a diode structure and the flowing current values of the control elements of the remaining LEDs in the LED load circuits are interlocked through control terminals.

According to the above described configuration, in an LED lighting circuit to be used for an illuminating apparatus and the like, when a current is allowed to flow from a DC power supply to an LED module made up of a plurality of LEDs, if the LED module is constructed of a plurality of serially connected LED load circuits, each being made up of a plurality of LEDs connected parallel to each other, control elements configuring a current mirror circuit are arranged in series to the LEDs, an LED with the highest ON voltage Vf in the LED load circuits is preferably used as a reference and the control element corresponding to the LED is to have a diode structure and the flowing current values of the control elements of the remaining LEDs in the same LED load circuit are interlocked through the control terminals and the LEDs are thereby balanced in the LED load circuit. To be more specific, when the control elements are transistors, the base and collector, which are control terminals, are short-circuited and the bases are connected commonly. On the other hand, when the control elements are MOS type transistors, the gate and drain, which are control terminals, are short-circuited and the gates are connected commonly. Since the respective LED load circuits are connected in series, the flowing currents are the same.

Therefore, the current balance in the LED load circuits is uniformly controlled by the current mirror circuit and it is thereby possible to uniformize light outputs from many LEDs. Furthermore, since an LED load circuit with the highest sum of ON voltages Vf is used for the circuit to create a reference current of the current mirror circuit, a circuit to create only a reference current is not necessary and circuit loss can be eliminated accordingly.

Furthermore, in the LED lighting circuit based on the first viewpoint of the present invention, the DC power supply is preferably a DC-DC converter and configured by including current detection means ectively detecting currents flowing through the LED module, a reference voltage source and a comparator for comparing the detection result from the current detection means and control means for controlling the DC power supply through feedback so that the sum of values of currents flowing to the LED module becomes a predetermined value according to the output of the comparator.

According to the above described configuration, the sum of values of currents flowing from the DC power supply to the LED load circuits is detected and the DC power supply is collectively subjected to constant current control through feedback based on the detection result so that the sum of the flowing current values becomes a predetermined value, and therefore losses at the control elements are smaller compared to constant voltage control, and losses can thereby be reduced.

Furthermore, the illuminating apparatus based on the first viewpoint of the present invention preferably uses the above described LED lighting circuit. According to the above described configuration, it is possible to uniformize light outputs from many LEDs and also realize a low loss illuminating apparatus.

### Embodiment Based on Second Viewpoint

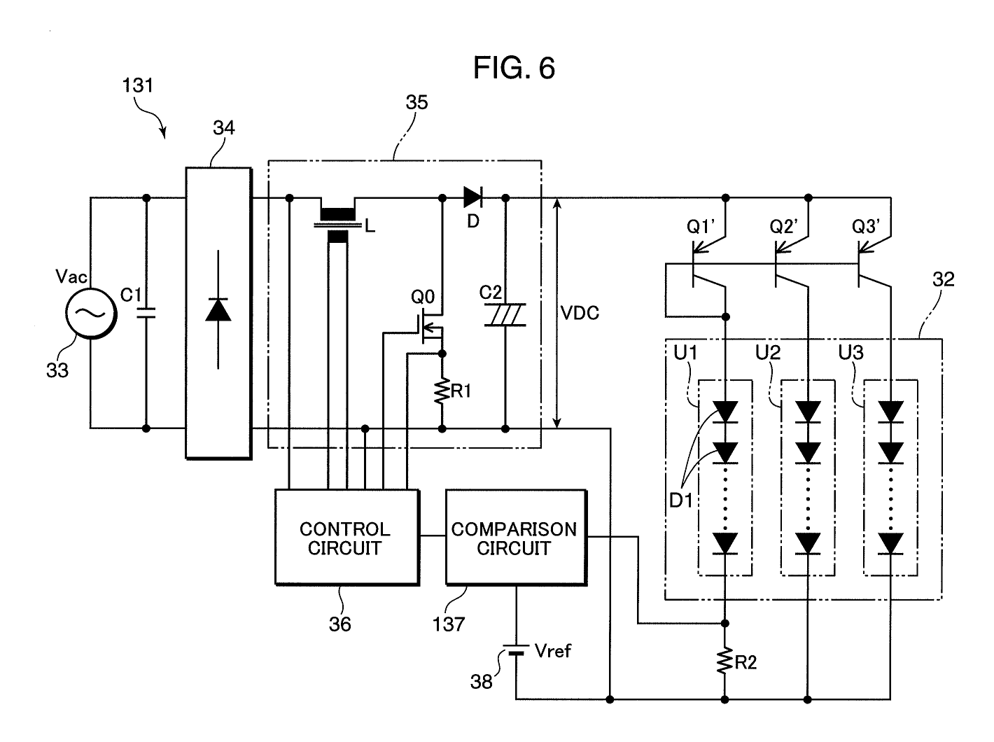

FIG. 6 is a block diagram showing a configuration of an LED lighting circuit 131 according to Embodiment 1 based on a second viewpoint of the present invention. This LED lighting circuit 131 is similar to the LED lighting circuit 31 shown in aforementioned FIG. 1 and corresponding parts will be shown assigned the same reference numerals. In this LED lighting circuit 131, an LED module 32 is also configured by connecting three LED load circuits U1 to U3 in parallel, each being made up of many serially connected LEDs D1. The number of serially connected LED loads in each LED load circuit U1 to U3 is arbitrary and can also be constructed of a single LED.

In each LED load circuit U1 to U3, LEDs D1 are mounted on and bonded to a common heat sink, and configured with a fluorescent substance for wavelength conversion and a light diffusion lens and the like attached. The LED module 32 and LED lighting circuit 31 are used as an illuminating apparatus, emit blue or ultraviolet light as the LED load, convert, in wavelength, the light from the LED load using the fluorescent substance and emit the light as white light. The number of parallel circuits of the LED load circuits U1 to U3 is also arbitrary and a technique for obtaining white light by combining light emitted in three primary colors RGB, for example, is also arbitrary.

A DC voltage VDC resulting from converting a voltage Vac from a commercial power supply 33 to DC through a noise cut capacitor C1 and a rectification bridge 34 and converting the DC to a voltage via a DC-DC converter 35 is added to the LED module 32. The DC-DC converter 35 is constructed of a voltage boosting chopper circuit configured by including a switching element Q0 that switches the DC output voltage of the rectification bridge 34, a choke coil L that stores/discharges excitation energy through the switching, a diode D and a smoothing capacitor C2 that rectify and smooth the output current from the choke coil L, a resistor R1 that converts a current flowing through the switching element Q0 to a voltage for detection and a control circuit 36 that controls the switching of the switching element Q0.

What should be noted is that according to the present embodiment, in the LED load circuits U1 to U3, control elements Q1′ to Q3′, which are P-type transistors configuring a current mirror circuit are arranged in series to equalize values of currents flowing through the LED load circuits U1 to U3, a circuit (U1 in FIG. 6) with the highest voltage drop by the LED currents including the sum the LED ON voltages Vf in the corresponding LED load circuits U1 to U3 in the control elements Q1′ to Q3′ is used as a reference, the control element in the circuit (Q1′ in the example of FIG. 6) is to have a diode structure, the flowing current values of the control elements (Q2′ and Q3′ in the example of FIG. 1) of the remaining circuits (U2 and U3 in the example of FIG. 6) are interlocked through control terminals and the LED load circuits U1 to U3 are thereby balanced.

To be more specific, when the control elements are transistors as shown in FIG. 6, the base and collector, which are the control terminals, are short-circuited for the control element Q1′ and the bases of the control elements Q1′ to Q3′ are commonly connected. On the other hand, when the control elements are MOS type transistors, the gate and drain, which are the control terminals, are short-circuited for the control element Q1′ and the gates of the control elements Q1′ to Q3′ are commonly connected.

Furthermore, the current flowing from the DC-DC converter 35, which is the DC power supply, to the LED module 32 is converted to a voltage value by a current detection resistor R2 inserted in the circuit (U1 in the example of FIG. 6) that serves as the reference, compared with a reference voltage Vref from a reference voltage source 38 by a comparison circuit 137 and the comparison result is fed back to the control circuit 36. In response to the detection result of the resistors R1 and R2, the control circuit 36 controls the switching frequency and duty of the switching element Q0. Constant voltage control over the voltage VDC and constant current control over the current that flows to the LED module 32 are performed in this way.

Therefore, since the current balance among the LED load circuits U1 to U3 is uniformly controlled by the current mirror circuit, light outputs from many LEDs D1 can be uniformized. Furthermore, since an LED load circuit (U1 in the example of FIG. 6) with the highest voltage drop by the LED currents including the sum of the ON voltages Vf is used for the circuit (Q1′ in the example of FIG. 6) for creating a reference current of the current mirror circuit, a circuit to create only a reference current is not necessary and circuit loss can be eliminated accordingly. Furthermore, the values of currents flowing from the DC-DC converter 35 to the LED load circuits U1 to U3 are controlled to be constant by the constant current control based on the detection result of the resistor R2, and therefore losses at the control elements Q1′ to Q3′ can be reduced compared to a case where only constant voltage control to keep the voltage VDC constant is performed. Furthermore, one of the control elements Q1′ to Q3′ of transistors and the like is to have a diode structure and simply configured into a mirror circuit, and therefore the present embodiment can be implemented in a low-cost configuration.

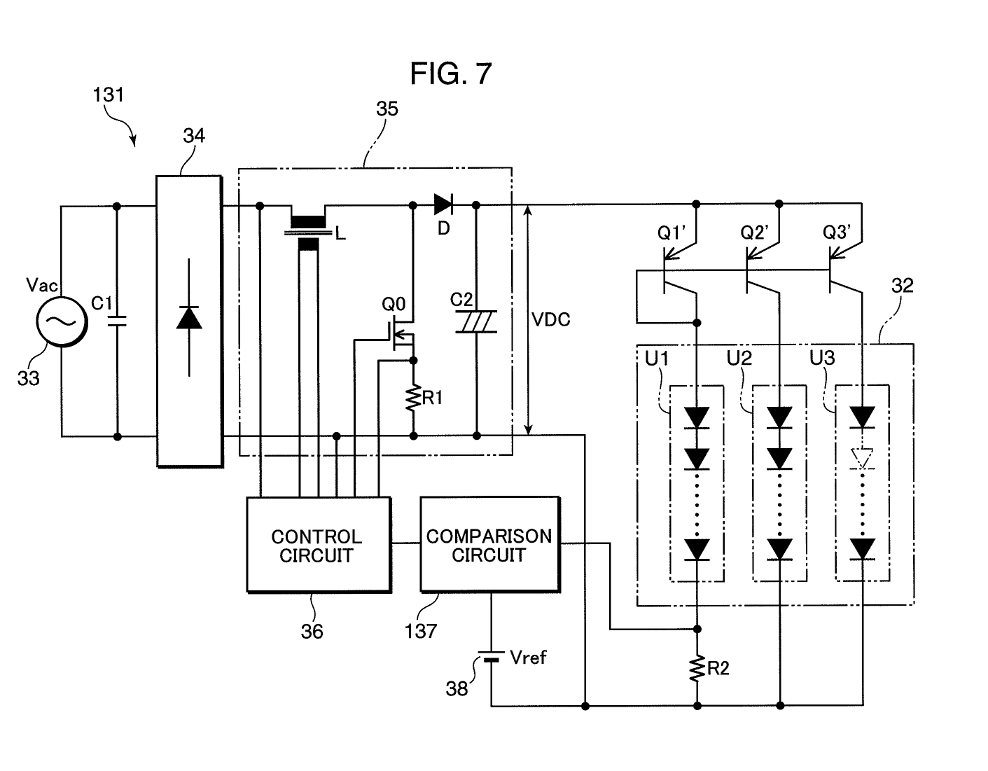

Furthermore, by inserting the current detection resistor R2 in the circuit (U1 in the example of FIG. 6) that serves as a reference as described above, even if wire breakage occurs in the LEDs D1 in circuits other than the circuit that becomes a reference (U3 in the example of FIG. 6) as shown in FIG. 7, the remaining circuits (U1 and U2 in the example of FIG. 6) can continue lighting with the current value remaining constant (without becoming overcurrent).

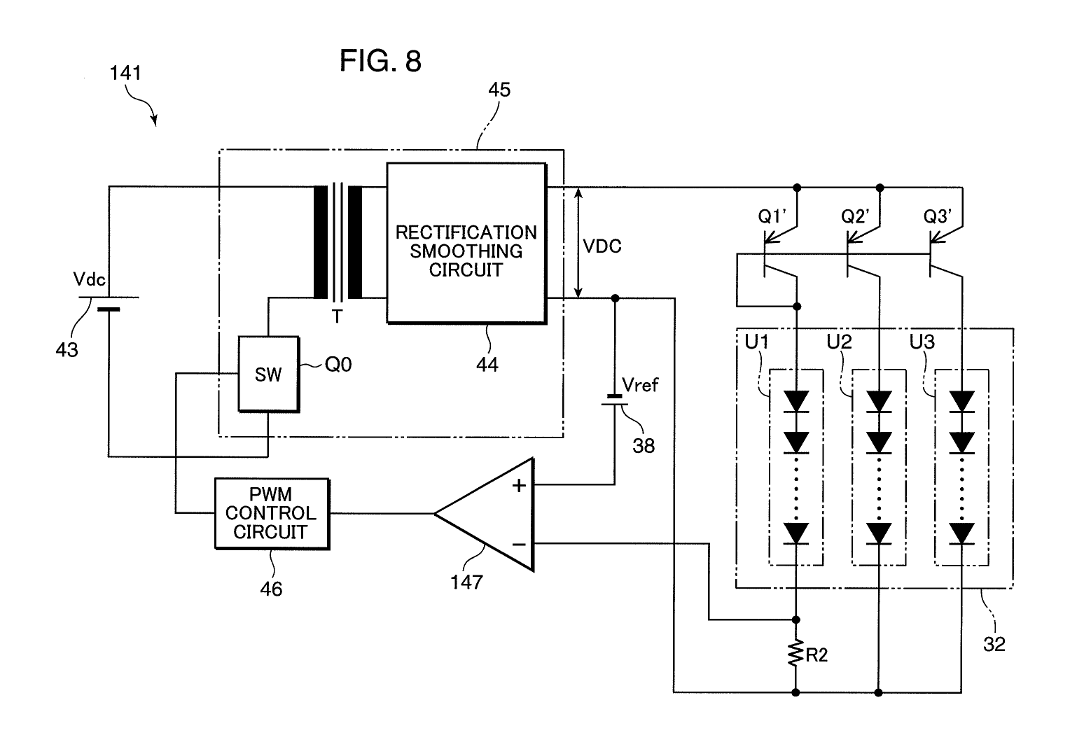

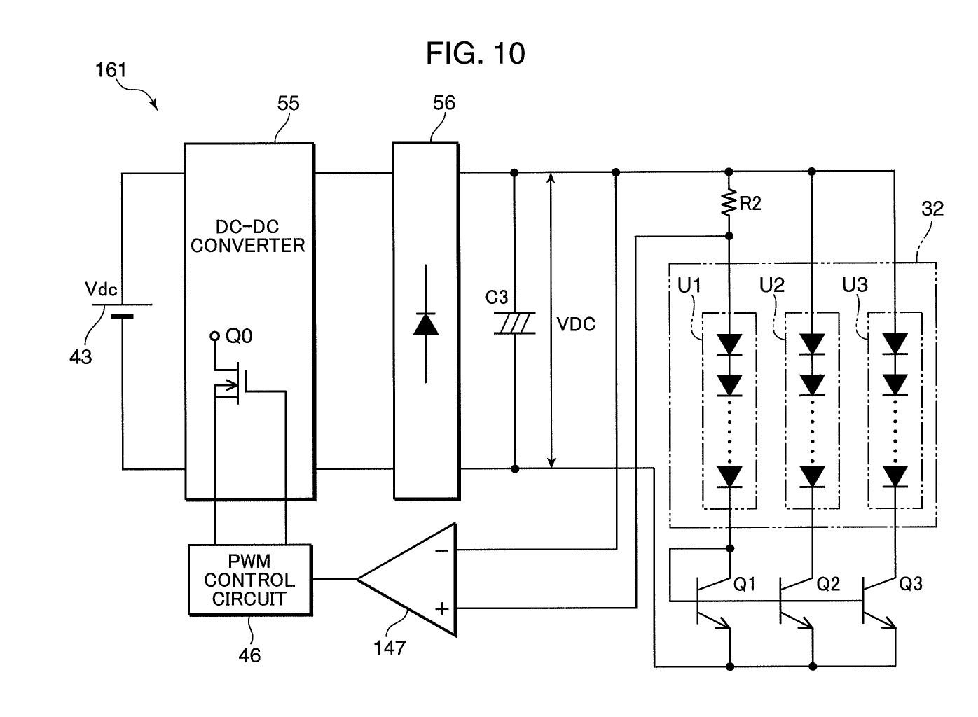

FIG. 8 to FIG. 10 are block diagrams showing configurations of LED lighting circuits 141, 151 and 161, the DC power supply of which has a different mode. In the configurations in FIG. 8 to FIG. 10, parts similar or corresponding to those shown in aforementioned FIG. 6 are assigned the same reference numerals and explanations thereof will be omitted. In the configurations in FIG. 8 to FIG. 10, the configuration of the LED module 32 made up of LED load circuits U1 to U3 is the same. However, as opposed to FIGS. 6, 8 and 9 where control elements Q1′ to Q3′ connected in series to the LED load circuits U1 to U3 are P-type transistors, control elements Q1 to Q3 in FIG. 10 are N-type transistors. However, also in the example of FIG. 10, a circuit with the highest sum of LED ON voltages Vf of the LED load circuits U1 to U3 is assumed to be the U1 and the corresponding control element Q1 has a diode structure and the flowing current values of the remaining circuits U2 and U3 are interlocked through the control elements Q2 and Q3.

The LED lighting circuit 141 shown in FIG. 8 is configured such that the value of a current flowing to the LED load circuit U1 is converted to a voltage and detected by a resistor R2, the voltage is compared with a reference voltage Vref from a reference voltage source 38 by a comparator 147 and a DC-DC converter 45 is controlled via a PWM control circuit 46 so that the comparison result is kept to a constant value. As described above, the DC-DC converter 45 is constructed of a one-transistor flyback converter that switches a voltage Vdc from a DC power supply 43 by a switching element Q0 and gives the voltage Vdc to the primary side of a transformer T, gives a DC voltage VDC resulting from rectifying/smoothing the secondary side output by a rectification smoothing circuit 44 to the LED load circuits U1 to U3 so as to insulate the power supply side from the load side. The LED lighting circuit 141 is also similar to the LED lighting circuit 11 shown in aforementioned conventional example in FIG. 30.

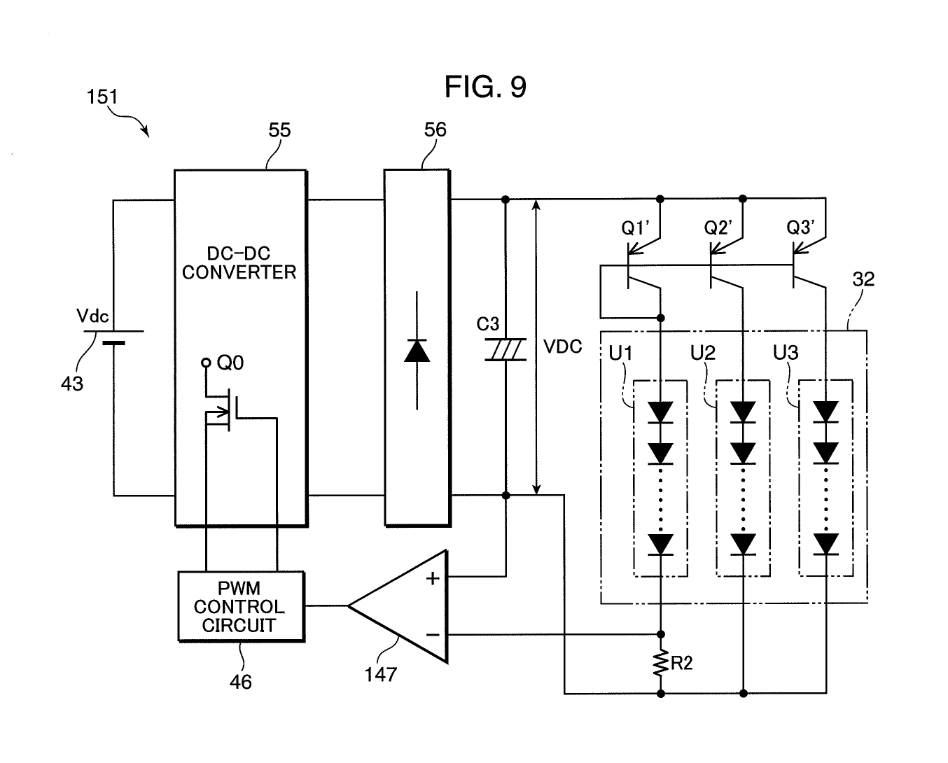

In the LED lighting circuits 151 and 161 shown in FIG. 9 and FIG. 10, a voltage Vdc from a DC power supply 43 is boosted or lowered by a DC-DC converter 55, rectified by a full-wave or half-wave rectifier 56, smoothed by a smoothing capacitor C3 and the resulting DC voltage VDC is given to the LED module 32. The value of the current flowing to the LED load circuit U1 is converted to a voltage and detected by the resistor R2, the voltage is compared with a reference voltage Vref by a comparator 147 and the PWM control circuit 46 controls the DC-DC converter 55 so that the comparison result is kept to a constant value.

In the explanations above, the emitter area ratios of the control elements (transistors) Q1′ to Q3′; Q1 to Q3, that is, rated currents of the LEDs D1 in the LED load circuits U1 to U3 are the same, but the emitter area ratios may also be configured to be different from each other and in such a case, the control elements Q1′ to Q3′; Q1 to Q3 perform control so as to maintain different set current ratios. Power consumption by a current detection resistor R2 can be reduced to a minimum by making such a setting that the sum of LED ON voltages Vf in an LED load circuit with the least current value becomes the highest. Furthermore, an organic EL (organic LED) is also applicable to the LEDs D1 in the present invention.

### Summary of Second Viewpoint

As described above, the LED lighting circuit based on the second viewpoint of the present invention is an LED lighting circuit that causes a current to flow from a DC power supply to an LED module made up of a plurality of LED load circuits arranged parallel to each other, each LED load circuit being made up of one or a plurality of serially connected LEDs, detects a value of the current flowing from the DC power supply to the LED module and controls the DC power supply through feedback based on the detection result so that the flowing current value is kept to a predetermined value, in which control elements configuring a current mirror circuit are preferably arranged in series to the LED load circuits, a circuit with the highest voltage drop by LED currents is used as a reference including the sum of LED ON voltages in the LED load circuits, the control element in the circuit is to have a diode structure, and the flowing current values of the control elements of the remaining circuits are interlocked through control terminals and current detection means for detecting the flowing current value is inserted in this circuit.

According to the above described configuration, in the LED lighting circuit to be used for an illuminating apparatus and the like, when a current is caused to flow from a DC power supply to an LED module made up of LED load circuits arranged parallel to each other, each LED load circuit being made up of one or a plurality of serially connected LEDs, a value of the current flowing from the DC power supply to the LED module is detected and the DC power supply is controlled through feedback based on the detection result so that the flowing current value is kept to a predetermined value, control elements configuring a current mirror circuit are arranged in series to the LED load circuits, a circuit with the highest voltage drop by LED currents including the sum of LED ON voltages in the LED load circuits is used as a reference, the control element in the circuit is to have a diode structure, and the flowing current values of the control elements of the remaining circuits are interlocked through the control terminals, the LED load circuits are thereby balanced and current detecting means for detecting the flowing current values such as a current/voltage conversion resistor is inserted in this circuit. To be more specific, when the control elements are transistors, the base and the collector, which are control terminals, are short-circuited and the bases are commonly connected. On the other hand, when the control elements are MOS type transistors, the gate and drain, which are control terminals, are short-circuited and the gates are commonly connected.

Therefore, since the currents flowing through the LED load circuits are controlled to be constant through the constant current control and current balance control, light outputs from many LEDs can be uniformized. Furthermore, since an LED load circuit with the highest sum of the ON voltages Vf is used for the circuit to create a reference current of the current mirror circuit, such a configuration does not require the circuit that creates only a reference current and can eliminate circuit loss accordingly. Furthermore, even when wire breakage occurs in the LEDs other than the circuit to be a reference, the remaining circuits can continue lighting with the current values remaining constant.

Furthermore, in the LED lighting circuit based on the second viewpoint of the present invention, the DC power supply is a DC-DC converter and is preferably configured by including a reference voltage source and a comparator to compare the detection results from the current detection means and control means for controlling the DC power supply so that the flowing current values to the LED module become the predetermined value according to the output from the comparator.

According to the above described configuration, since constant current control is performed to control the DC power supply through feedback, losses at the control elements are small compared to constant voltage control and losses can be reduced.

Furthermore, the illuminating apparatus based on the second viewpoint of the present invention is preferably designed to use the above described LED lighting circuit. The above described configuration can uniformize light outputs from many LEDs and realize a low-loss illuminating apparatus.

### Embodiment 1 Based on Third Viewpoint

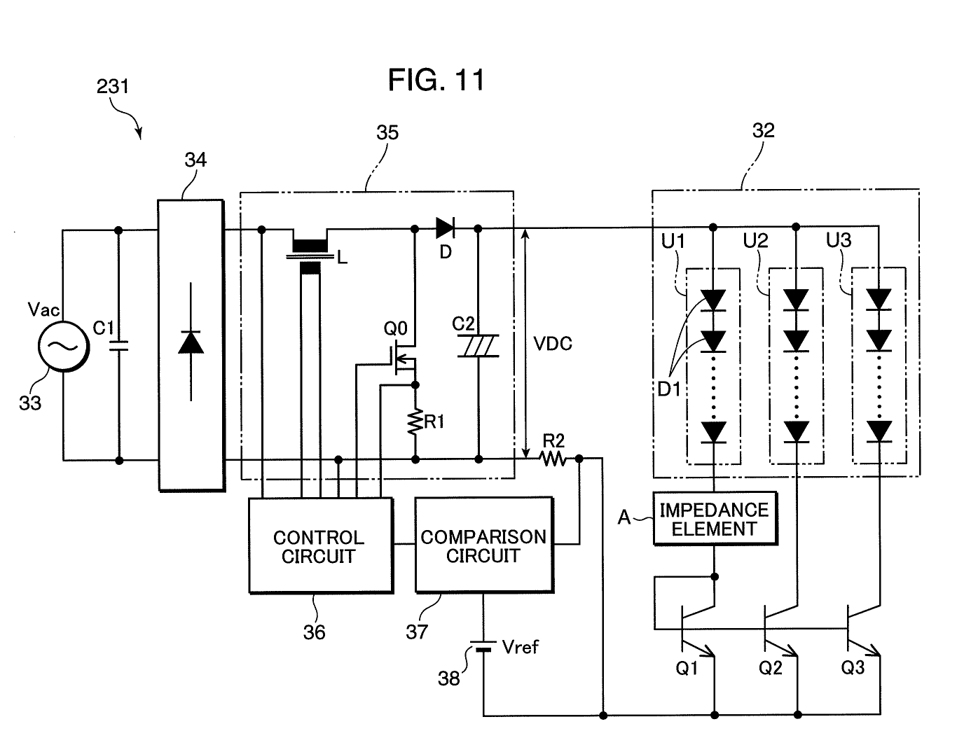

FIG. 11 is a block diagram showing a configuration an LED lighting circuit 231 according to Embodiment 1 based on a third viewpoint of the present invention. This LED lighting circuit 231 is similar to the LED lighting circuit 31 shown in aforementioned FIG. 1 and corresponding parts will be shown assigned the same reference numerals. Also in this LED lighting circuit 231, an LED module 32 is configured with three LED load circuits U1 to U3 connected in parallel, each LED load circuit being made up of many serially connected LEDs D1. The number of series LED loads in each LED load circuit U1 to U3 is arbitrary and each LED load circuit may also be constructed of a single LED.

Each LED load circuit U1 to U3 is configured such that the LEDs D1 are mounted on and bonded to a common heat sink and a fluorescent substance for wavelength conversion and a light diffusion lens and the like are also attached. The LED module 32 and the LED lighting circuit 231 are used as an illuminating apparatus, and emit blue or ultraviolet light as the LED load, convert, in wavelength, the light from the LED load using the fluorescent substance and emit the light as white light. The number of parallel circuits of the LED load circuits U1 to U3 is also arbitrary and a technique for obtaining white light by combining light emitted in three primary colors RGB, for example, is also arbitrary.

A DC voltage VDC resulting from converting a voltage Vac from a commercial power supply 33 to DC through a noise cut capacitor C1 and a rectification bridge 34 and converting the DC to a voltage via a DC-DC converter 35 is added to the LED module 32. The DC-DC converter 35 is constructed of a voltage boosting chopper circuit configured by including a switching element Q0 that switches the DC output voltage of the rectification bridge 34, a choke coil L that stores/discharges excitation energy through the switching, a diode D and a smoothing capacitor C2 that rectify and smooth the output current from the choke coil L, a resistor R1 that converts a current flowing through the switching element Q0 to a voltage for detection and a control circuit 36 that controls the switching of the switching element Q0.

The current that flows from the DC-DC converter 35, which is a DC power supply, to the LED module 32 is converted to a voltage value by a current detection resistor R2, compared with a reference voltage Vref from a reference voltage source 38 by a comparison circuit 37 and the comparison result is fed back to the control circuit 36. The control circuit 36 controls the switching frequency and duty of the switching element Q0 in response to the detection results of the resistors R1 and R2. Constant voltage control over the voltage VDC and constant current control over the current that flows to the LED module 32 are performed in this way.

What should be noted is that according to the present embodiment, in the LED load circuits U1 to U3, the control elements Q1 to Q3 configuring a current mirror circuit are arranged in series to equalize values of currents flowing through the LED load circuits U1 to U3, one of the control elements Q1 to Q3 (Q1 in the example of FIG. 11) is to have a diode structure so as to become a reference current circuit of the current mirror, the flowing current values of the remaining control circuits (U2 and U3 in the example of FIG. 11) are interlocked through control terminals and the LED load circuits U1 to U3 are thereby balanced.

To be more specific, when the control elements Q1 to Q3 are transistors as shown in FIG. 11, the base and collector, which are the control terminals in the control element Q1, are short-circuited and the bases of the control elements Q1 to Q3 are commonly connected. On the other hand, when the control terminals are MOS type transistors, the gate and drain, which are the control terminals in the control element Q1, are short-circuited and the gates of the control elements Q1 to Q3 are commonly connected.

What should be further noted is that an impedance element A is inserted in series in the LED load circuit U1 of the control element Q1 been to have the diode structure and the impedance element A is made to produce a voltage drop Va equal to or greater than Vf×n×σ at a rated current, where Vf is the ON voltage of the LED D1, σ is a variance thereof and n is the number of serially connected diodes.

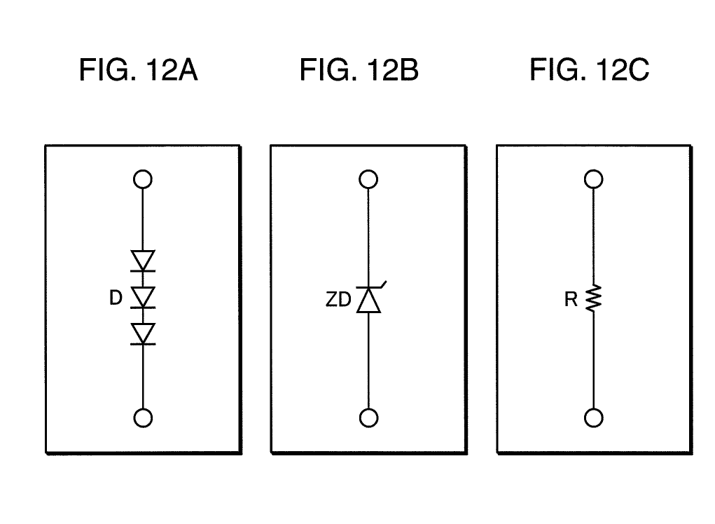

The impedance element A can be realized from, for example, one or a plurality of diodes as shown in FIG. 12A, a Zener diode as shown in FIG. 12B, a resistor as shown in FIG. 12C, and the like. When the diodes shown in FIG. 12A are used, for example, a small variation of 0.7 V can be handled by a single diode, and when the Zener diode shown in FIG. 12B is used, a large variation equal to or greater than 2 V as the sum of the ON voltages Vf can be handled and when such a resistor as shown in FIG. 12C is used, loss is produced all the time but the resistor can handle a smaller variation than by the diode and is suitable for when the variations in the ON voltages Vf are small or when the number of LEDs D1 is small.

Configured as shown above, even when there are variations in the ON voltages Vf of the LEDs D1, the circuit that creates a reference current of the current mirror circuit is a circuit with the highest voltage drop by LED currents including the sum of the ON voltages Vf of the LEDs D1, and it is thereby possible to uniformly control the current values in the LED load circuits U1 to U3 and uniformize light outputs from many LEDs D1. Furthermore, such a configuration does not require the circuit that creates only a reference current and can eliminate circuit loss accordingly. Furthermore, one of the control elements Q1 to Q3 of transistors and the like is to have a diode structure and simply configured into a mirror circuit, and therefore the circuit can be realized in a low-cost configuration.

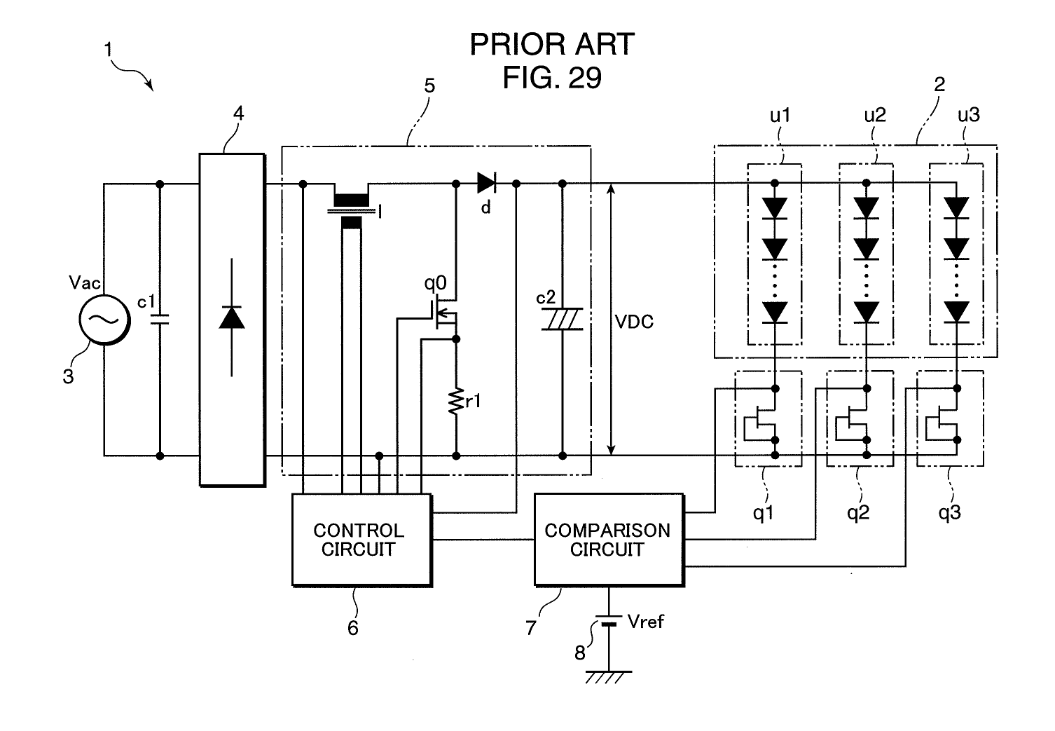

Although the DC power supply of this LED lighting circuit 231 is the DC-DC converter 35 having the choke coil L as in the case of the LED lighting circuit 1 in the aforementioned conventional example shown in FIG. 29, the DC power supply may also be an insulation type DC-DC converter having the transformer t in the conventional example shown in FIG. 30, and the DC power supply to the LED module 32 in particular is arbitrary. However, when constant current control through current mirror operation using the control elements Q1 to Q3 is performed, use of constant current control is preferable to use of constant voltage control for the DC power supply.

In the above described explanations, the emitter area ratios of the control elements (transistors) Q1 to Q3, that is, the rated currents of LEDs D1 of the LED load circuits U1 to U3 are the same, but the rated currents may also be configured to be different from each other, and in that case, the control elements Q1 to Q3 perform control so as to maintain the different set current ratios. Furthermore, organic EL (organic LED) may also be applicable to the LEDs D1 of the present invention.

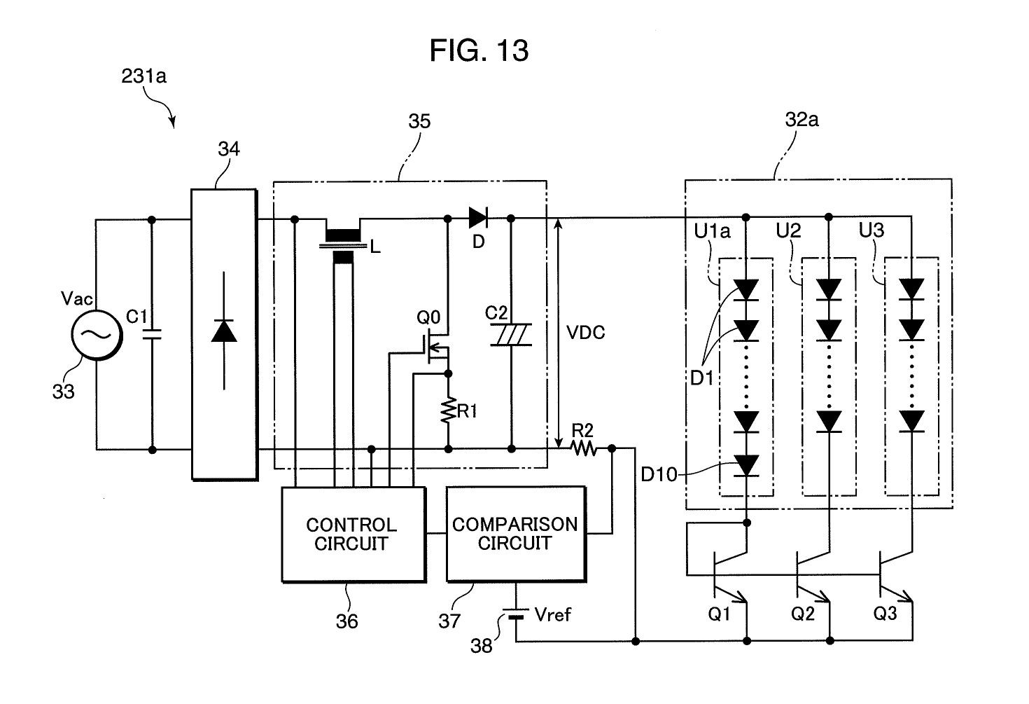

Furthermore, the impedance element A can also be realized using an LED, and in that case, as shown with an LED lighting circuit 231a in FIG. 13, in an LED load circuit U1a of an LED module 32a, it is only necessary to provide an extra LED D10 to set a greater number of series LEDs of the LED load circuit U1a than the remaining LED load circuits U2 and U3. For example, assuming the accuracy variation of the ON voltages Vf of the LEDs D1 is σ and the number of serially connected diodes is n, when σ is on the order of 10%, a setting can be made such that the sum of ON voltages Vf of the LED load circuit U1a is always the highest, for example, the number of additional LEDs D10 is 1 up to the order of n=10 and 2 up to the order of n=20. By adopting such a configuration, it is possible to easily adopt a configuration in which the sum of the ON voltages Vf is the highest and effectively use power consumption by the impedance element A.

### Embodiment 2 Based on Third Viewpoint

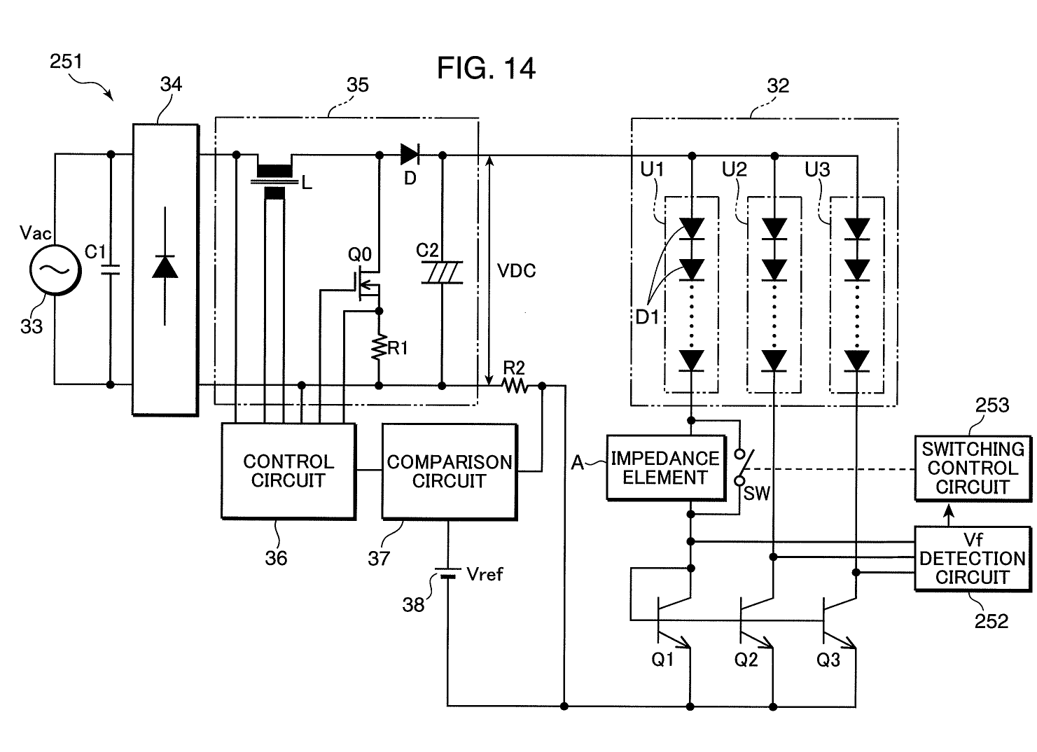

FIG. 14 is a block diagram showing a configuration of an LED lighting circuit 251 according to Embodiment 2 based on the third viewpoint of the present invention. In this LED lighting circuit 251, parts similar and corresponding to those of the aforementioned LED lighting circuit 231 are assigned the same reference numerals and explanations thereof will be omitted. What should be noted is that in this LED lighting circuit 251, a short-circuit switch SW is provided between terminals of the impedance element A and in a condition in which the short-circuit switch SW is opened and the control elements Q1 to Q3 are performing current mirror operation, a Vf detection circuit 252 detects the sum of LED ON voltages Vf in the LED load circuits U1 to U3, and based on the detection result, the switching control circuit 253 closes the short-circuit switch SW when the sum of the ON voltages Vf of the LED load circuit U1 where the control element Q1 has the diode structure is the highest, and opens the short-circuit switch SW otherwise.

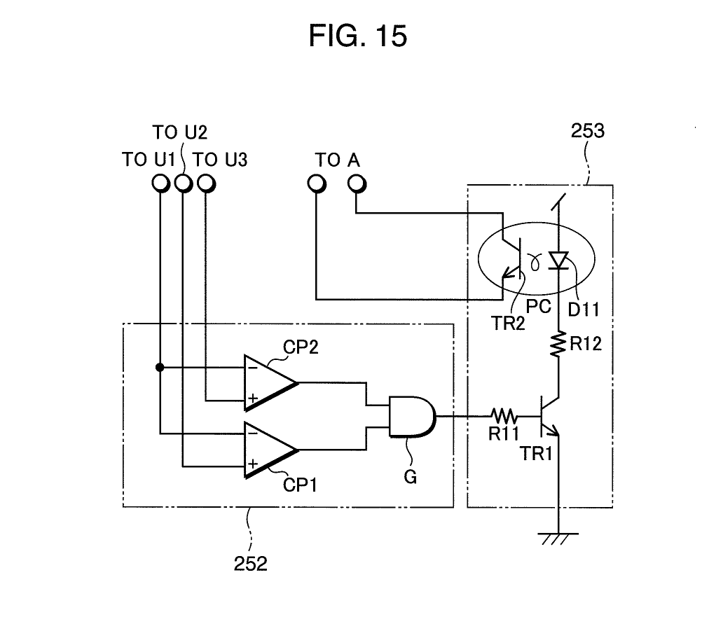

FIG. 15 is a block diagram showing a configuration example of the Vf detection circuit 252 and the switching control circuit 253. The Vf detection circuit 252 is configured by including two comparators CP1 and CP2 and an AND gate G that adds up those outputs. The terminal voltage of the LED load circuit U1 for which the impedance element A is commonly provided is given to the non-inverted input ends of the comparators CP1 and CP2, and the terminal voltages of the LED load circuits U2 and U3 for which the impedance element A is not provided are given to the non-inverted input ends. Therefore, when the terminal voltage of the LED load circuit U1 is lower, that is, when the amount of voltage drop from the output voltage VDC of the DC-DC converter 35 is higher, high level is outputted from the comparators CP1 and CP2, and when the amount of voltage drop from the LED load circuit U1 is highest, high level is outputted from the AND gate G.

The switching control circuit 253 is configured by including a transistor TR1, to the base of which the output of the AND gate G is given, a base resistor R11 and a collector resistor R12 thereof and a photocoupler PC which is driven by the transistor TR1 via the collector resistor R12. Therefore, when high level is outputted from the AND gate G, the transistor TR1 turns ON, a photodiode D11 of the photocoupler PC lights up, a phototransistor TR2 configuring the short-circuit switch SW turns ON, which causes the impedance element A to be bypassed.

Configured as shown above, when an attempt is made to perform current uniformizing operation using a current mirror as described above, the circuit with the highest sum of the ON voltages Vf of the LEDs D1 must become the reference current circuit, and since when the Vf detection circuit 252 actually measures the sum of the LED ON voltage Vf in the LED load circuits U1 to U3, the switching control circuit 253 inserts the impedance element A only when the impedance element A is necessary, it is possible to cause the impedance element A to function only when required and reduce losses at the impedance element A.

### Embodiment 3 Based on Third Viewpoint

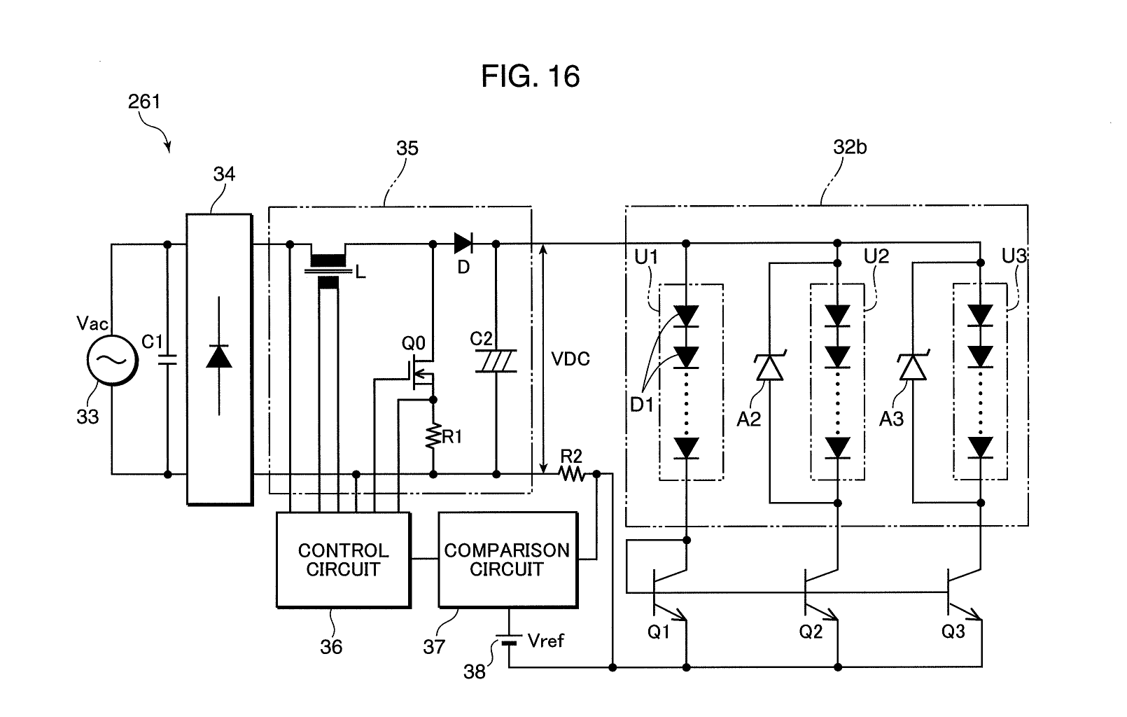

FIG. 16 is a block diagram showing a configuration of an LED lighting circuit 261 according to Embodiment 3 based on the third viewpoint of the present invention. In this LED lighting circuit 261, parts similar and corresponding to those of the aforementioned LED lighting circuit 231 are shown assigned the same reference numerals, and explanations thereof will be omitted. What should be noted is that in this LED lighting circuit 261, an LED module 32b is provided with impedance elements A2 and A3 in parallel between the terminals of LED load circuits U2 and U3 where control elements Q2 and Q3 do not form the diode structure. These impedance elements A2 and A3 are intended to reduce the impedance of the corresponding LED load circuits U2 and U3 and clamp the inter-terminal voltage so as to be lower than the inter-terminal voltage of the LED load circuit U1 and are made up of, for example, a Zener diode shown in FIG. 16, or a configuration with a resistor element further connected in series to the Zener diode may also be used.

Configured in this way, the LED load circuit U1 that creates a reference current of the current mirror circuit is a circuit with the highest voltage drop by LED currents including the sum of the ON voltages Vf of the LEDs D1 even if there are variations in the ON voltages Vf of the LEDs D1, and can still uniformly control current values in the LED load circuits U1 to U3 and uniformize light outputs from many LEDs D1. Furthermore, such a configuration does not require the circuit that creates only a reference current and can eliminate circuit loss accordingly.

### Embodiment 4 Based on Third Viewpoint

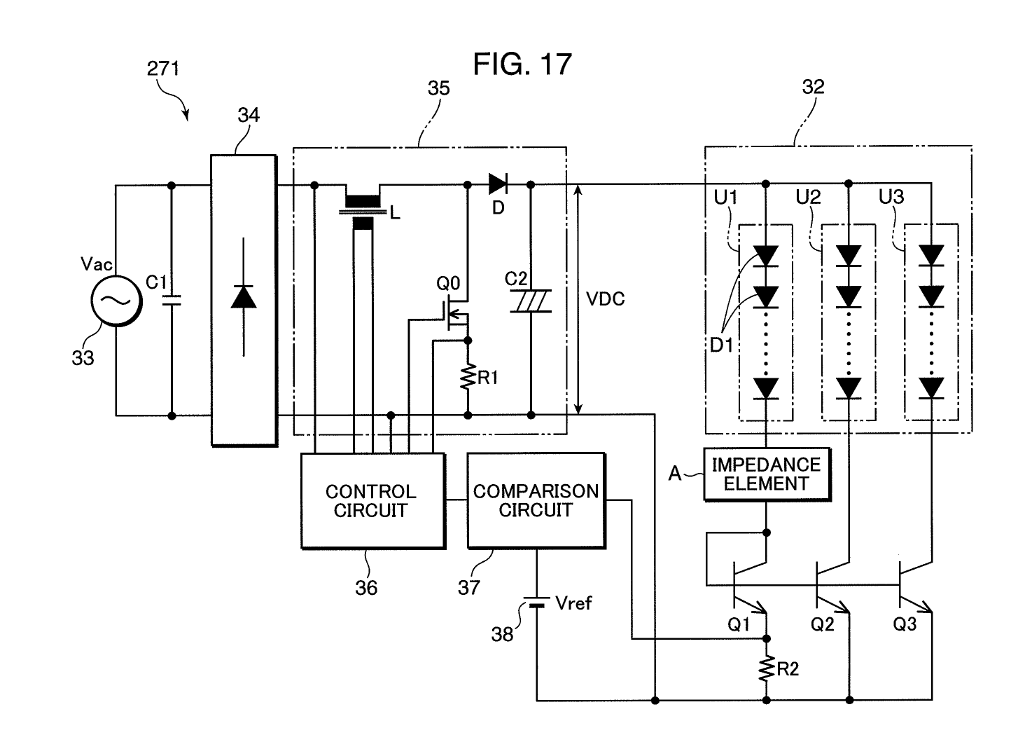

FIG. 17 is a block diagram showing a configuration of an LED lighting circuit 271 according to Embodiment 4 based on the third viewpoint of the present invention. In this LED lighting circuit 271, parts similar and corresponding to those of the aforementioned LED lighting circuit 231 are shown assigned the same reference numerals, and explanations thereof will be omitted. What should be noted is that when performing feedback control over constant currents of the DC-DC converter 35, in this LED lighting circuit 271, a current detection resistor R2 is inserted in one of the LED load circuits U1 to U3 (U1 in the example of FIG. 17). In this case, loss by the resistor R2 can be reduced (in the example of FIG. 17, approximately ⅓ of that in the example of FIG. 11). Furthermore, even if wire breakage occurs in LEDs D1 of any LED load circuit other than the LED load circuit which becomes a reference, the remaining circuits can continue lighting with the constant current values.

Here, Japanese Patent Laid-Open No. 2006-203044 describes that when currents of the parallel LEDs having different ON voltages Vf are adjusted, transistors are connected in series, their gates are commonly driven, and further dummy diodes are connected in series to LEDs with the small ON voltages Vf so as to reduce differences in the ON voltages Vf. However, this prior art separately creates a reference current of the current mirror and inserts a diode to reduce the difference in the ON voltages Vf, whereas the present embodiment inserts a diode so as to increase the difference in the ON voltages Vf so that a reference current of the current mirror can be created. Therefore, when white light is produced through RGB light emission as in the case of this prior art, a diode is inserted in the element of R having a small ON voltage Vf (on the order of 2 V) according to this prior art, whereas in the present embodiment, a diode is inserted in the system of the element of B with a higher ON voltage Vf (on the order of 3 to 3.5 V), which is totally different.

### Summary of Third Viewpoint

As described above, the LED lighting circuit based on the third viewpoint of the present invention is an LED lighting circuit that causes a current to flow from a DC power supply to an LED module made up of a plurality of LED load circuits arranged parallel to each other, each LED load circuit being made up of one or a plurality of serially arranged LEDs, preferably including control elements arranged in series to the LED load circuits, configuring a current mirror circuit so as to interlock flowing current values in the LED load circuits, one of which is to have a diode structure so as to be a reference current circuit of the current mirror, and an impedance element inserted in series in the circuit of the control element having the diode structure producing a voltage drop of equal to or higher than Vf×n×σ at a rated current, where Vf is an LED ON voltage, σ is a variation thereof and n is the number of serially connected diodes.

According to the above described configuration, in the LED lighting circuit to be used for an illuminating apparatus and the like, when a DC power supply drives lighting of an LED module made up of a plurality of LED load circuits arranged parallel to each other, each LED load circuit being made up of one or a plurality of serially arranged LEDs, control elements configuring a current mirror circuit are arranged in series to the LED load circuits, one of the control elements is to have a diode structure so as to be a reference current circuit of the current mirror, flowing current values of the control elements of the remaining circuits are interlocked through the control terminals and the LED load circuits are thereby balanced. To be more specific, when the control elements are transistors, the base and collector, which are the control terminals, are short-circuited and the bases are commonly connected. On the other hand, when the control terminals are MOS type transistors, the gate and drain, which are the control terminals, are short-circuited and the gates are commonly connected. Furthermore, an impedance element which can be realized with a diode and the like is inserted in series to the circuit of the control element which is to have the diode structure producing a voltage drop of equal to or higher than Vf×n×σ at a rated current, where Vf is an LED ON voltage, σ is a variation thereof and n is the number of serially connected diodes.

Therefore, even if there is a variation in the LED ON voltages Vf, the circuit that creates a reference current of the current mirror circuit is a circuit with the highest voltage drop by LED currents including the sum of LED ON voltages Vf, and can thereby uniformly control current values in the LED load circuits and uniformize light outputs from many LEDs. Furthermore, such a configuration does not require the circuit that creates only a reference current and can eliminate circuit loss accordingly.

Furthermore, in the LED lighting circuit based on the third viewpoint of the present invention, the impedance elements are preferably LEDs. According to the above described configuration, by only setting a greater number of series LEDs of the LED load circuit which becomes a reference current circuit of the current mirror, it is possible to make such a setting that the sum of the ON voltages Vf becomes the highest, easily configure the apparatus and effectively use power consumption by the impedance element.

Furthermore, the LED lighting circuit based on the third viewpoint of the present invention preferably includes a short-circuit switch that can short-circuit between terminals of the impedance element, detection means for detecting the sum of the LED ON voltages Vf in the LED load circuits when the short-circuit switch is opened and the control element is performing current mirror operation and switching control means for responding to the detection result of the detection means, closing the short-circuit switch when the sum of the ON voltages Vf of the LED load circuit whose control element has the diode structure is the highest and closing the short-circuit switch otherwise.

According to the above described configuration, when an attempt is made to perform current uniformizing operation using the current mirror as described above, the circuit with the highest sum of the ON voltages Vf of the LEDs D1 must become the reference current circuit, and a short-circuit switch that short-circuits between the terminals of the impedance element is provided beforehand, the detection means actually measures the sum of the LED ON voltages Vf in the LED load circuits, the switching control means closes the short-circuit switch so as not to allow the impedance element to function when the sum of the ON voltages Vf of the LED load circuit whose control element has a diode structure is the highest, and opens the short-circuit switch otherwise to allow the impedance element to function. Therefore, it is possible to allow the impedance element to function for aging and the like only when required, and suppress losses at the impedance element.

Furthermore, the LED lighting circuit based on the third viewpoint of the present invention is an LED lighting circuit that causes a current to flow from a DC power supply to an LED module made up of a plurality of LED load circuits arranged parallel to each other, each LED load circuit being made up of one or a plurality of serially connected LEDs, preferably including control elements arranged in series to the LED load circuits configuring a current mirror circuit and interlocks flowing current values in the LED load circuits, one of which is to have a diode structure so as to be a reference current circuit of the current mirror, and an impedance element inserted parallel to circuits other than the circuit of the control element having the diode structure that reduces the impedance of the LED load circuit.

According to the above described configuration, in the LED lighting circuit to be used for an illuminating apparatus and the like, when a DC power supply drives lighting of an LED module made up of a plurality of LED load circuits arranged parallel to each other, each LED load circuit being made up of one or a plurality of serially connected LEDs, control elements configuring a current mirror circuit are arranged in series to the LED load circuits, one of the control elements is to have a diode structure so as to be a reference current circuit of the current mirror, flowing current values of the control elements of the remaining circuits are interlocked through control terminals and the LED load circuits are thereby balanced. To be more specific, when the control elements are transistors, the base and collector, which are the control terminals, are short-circuited and the bases are commonly connected. On the other hand, when the control terminals are MOS type transistors, the gate and drain, which are the control terminals, are short-circuited and the gates are commonly connected. Furthermore, an impedance element for reducing the impedance of the LED load circuit is inserted parallel to circuits other than the circuit of the control element having the diode structure.

Therefore, even if there is a variation in the LED ON voltages Vf, the circuit to create a reference current of the current mirror circuit is designed to be a circuit with the highest voltage drop by LED currents including the sum of the LED ON voltages Vf, and can uniformly control the current value in the LED load circuits and uniformize light outputs from many LEDs. Furthermore, such a configuration does not require the circuit that creates only a reference current and can eliminate circuit loss accordingly.

Furthermore, in the LED lighting circuit based on the third viewpoint of the present invention, the DC power supply is a DC-DC converter and is preferably configured by including the current detection means for detecting a total value of currents flowing through the LED load circuits or a value of current flowing through the LED load circuit corresponding to the diode-connected control element, a reference voltage source and a comparator for comparing the detection results from the current detection means and control means for controlling the DC power supply through feedback so that the sum of values of currents flowing to the LED module becomes a predetermined value according to the output from the comparator.

According to the above described configuration, the values of currents flowing from the DC power supply to the LED load circuits are detected, the DC power supply is subjected to constant current control through feedback so that the sum of the flowing current values becomes a predetermined value based on the detection results, and therefore losses at the control elements are small compared to constant voltage control and losses can be reduced.

The illuminating apparatus based on the third viewpoint of the present invention preferably uses the above described LED lighting circuit. The above described configuration can uniformize light outputs from many LEDs even if the LED ON voltages (Vf) vary to an extreme degree and realize a low-loss illuminating apparatus.

### Embodiment 1 Based on Fourth Viewpoint

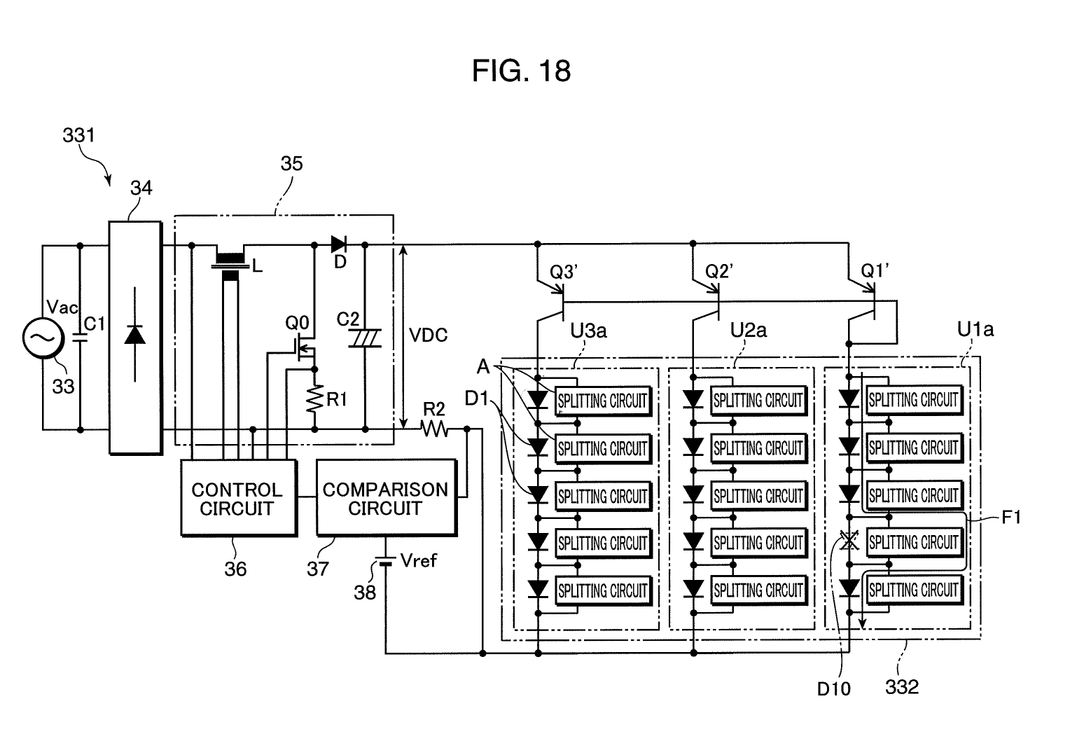

FIG. 18 is a block diagram showing a configuration of an LED lighting circuit 331 according to Embodiment 1 based on a fourth viewpoint of the present invention. In this LED lighting circuit 331, three LED load circuits U1a to U3a are connected parallel to each other, each LED load circuit being made up of many serially connected LEDs D1 to configure an LED module 332. The number of series LED loads in each LED load circuit U1a to U3a is arbitrary and each LED load circuit may also be constructed of a single LED.

In the LED load circuits U1a to U3a, LEDs D1 are mounted on and bonded to a common heat sink, and configured with a fluorescent substance for wavelength conversion and a light diffusion lens and the like attached. The LED module 332 and LED lighting circuit 331 are used as an illuminating apparatus, emit blue or ultraviolet light as the LED load, convert, in wavelength, the light from the LED load using the fluorescent substance and emit the light as white light. The number of parallel LED load circuits U1a to U3a is also arbitrary and a technique for obtaining white light by combining light emitted in three primary colors RGB, for example, is also arbitrary.

A DC voltage VDC resulting from converting a voltage Vac from a commercial power supply 33 to DC through a noise cut capacitor C1 and a rectification bridge 34 and converting the DC to a voltage via a DC-DC converter 35 is added to the LED module 332. The DC-DC converter 35 is constructed of a voltage boosting chopper circuit configured by including a switching element Q0 that switches the DC output voltage of the rectification bridge 34, a choke coil L that stores/discharges excitation energy through the switching, a diode D and a smoothing capacitor C2 that rectify and smooth the output current from the choke coil L, a resistor R1 that converts a current flowing through the switching element Q0 to a voltage for detection and a control circuit 36 that controls the switching of the switching element Q0.

The current that flows from the DC-DC converter 35, which is a DC power supply, to the LED module 332 is converted to a voltage value by the current detection resistor R2, compared with a reference voltage Vref from a reference voltage source 38 by a comparison circuit 37 and the comparison result is fed back to the control circuit 36. In response to the detection results of the resistors R1 and R2, the control circuit 36 controls the switching frequency and duty of the switching element Q0. Constant voltage control over the voltage VDC and collective constant current control over the current that flows to the LED module 332 are performed in this way.

In the LED load circuits U1a to U3a, control elements Q1′ to Q3′ configuring a current mirror circuit are arranged in series to equalize values of currents flowing through the LED load circuits U1a to U3a, a circuit (U1a in the example of FIG. 18) of the circuit with the highest voltage drop by LED currents including the sum of the LED ON voltages Vf in the corresponding LED load circuits U1a to U3a in the control elements Q1′ to Q3′ is used as a reference, the control element (Q1′ in the example of FIG. 18) is to have a diode structure and the flowing current values of the control elements (Q2′ and Q3′ in the example of FIG. 18) of the remaining circuits are interlocked through control terminals and the LED load circuits U1a to U3a are thereby balanced.

To be more specific, when the control elements Q1′ to Q3′ are transistors as shown in FIG. 18, the base and collector, which are the control terminals, are short-circuited and the bases are commonly connected. On the other hand, when the control terminals are MOS type transistors, the gate and drain, which are the control terminals, are short-circuited and the gates are commonly connected.

What should be noted is that in the present embodiment, splitting circuits A are arranged parallel to the LEDs D1 and each splitting circuit A allows a current at a level predefined for the LED D1 in the event of wire breakage of the corresponding LEDs (D1 in the example of FIG. 18) to pass by bypassing the LEDs as shown by reference character F1 in FIG. 18.

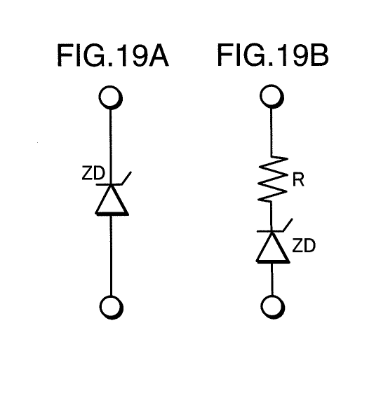

To be more specific, the splitting circuit A is constructed of elements or a circuit capable of generating a constant current such as a Zener diode ZD as a single unit as shown in FIG. 19A and a series circuit of a Zener diode ZD and a resistor R as shown in FIG. 19B and the flowing current value thereof is a value preset in the respective LED load circuits U1a to U3a. A Zener diode provided for anti-static measures can also be used for the Zener diode ZD provided parallel to the LEDs D1.

Configured as shown above, the sum of values of currents flowing from the DC-DC converter 35 to the LED load circuits U1a to U3a is controlled to be constant through collective constant current control based on the detection result of the resistor R2 and the current balance among the LED load circuits U1a to U3a is uniformly controlled by the current mirror circuit, and so light outputs from many LEDs D1 can be uniformized. Furthermore, since the LED load circuit (U1a in the example of FIG. 18) with the highest sum of the ON voltages Vf of the LEDs D1 is used for the circuit that creates a reference current of the current mirror circuit, such a configuration does not require the circuit that creates only a reference current and can eliminate circuit loss accordingly. Furthermore, since one of the control elements Q1′ to Q3′ such as transistors is to have a diode structure and simply configured into a mirror circuit, currents can be uniformized in a low-cost configuration.

The DC power supply of this LED lighting circuit 331 is a DC-DC converter 35 having the choke coil L, but the DC power supply may also be an insulation-type DC-DC converter having the transformer t shown in the aforementioned conventional example in FIG. 30 and the DC power supply corresponding to the LED module 332 in particular is arbitrary. However, when constant current control through current mirror operation using the control elements Q1′ to Q3′ is performed, use of constant current control is preferable to use of constant voltage control for the DC power supply.

In the above described explanations, the emitter area ratios of the control elements (transistors) Q1′ to Q3′, that is, the rated currents of LEDs D1 of the LED load circuits U1′ to U3′ are the same, but the rated currents may also be configured to be different from each other and in such a case, the control elements Q1′ to Q3′ perform control so as to maintain the different set current ratios. Furthermore, organic EL (organic LED) may also be applicable to the LEDs D1 of the present invention.

Furthermore, configured as in the present embodiment, the DC-DC converter 35 collectively drives lighting of the LED module 332 made up of a plurality of LEDs D1 with a constant current, and even if wire breakage occurs in an arbitrary LED D10, the current that should flow to the LED D10 is made to bypass the wire breakage location and flow at the same level as before the wire breakage through the splitting circuit A, and it is thereby possible to prevent an overcurrent from flowing to the remaining LED load circuits U2a and U3a causing lighting up in an overloaded condition and prevent malfunction from escalating into a chain reaction.

Furthermore, the splitting circuit A is constructed of a Zener diode ZD or a series circuit of a Zener diode ZD and a resistor R arranged parallel to the LED D1 and is especially suitable as a splitting circuit provided for every one or a small number of LEDs, eliminates continuous loss and allows a bypass of the current upon detection of wire breakage.

### Embodiment 2 Based on Fourth Viewpoint

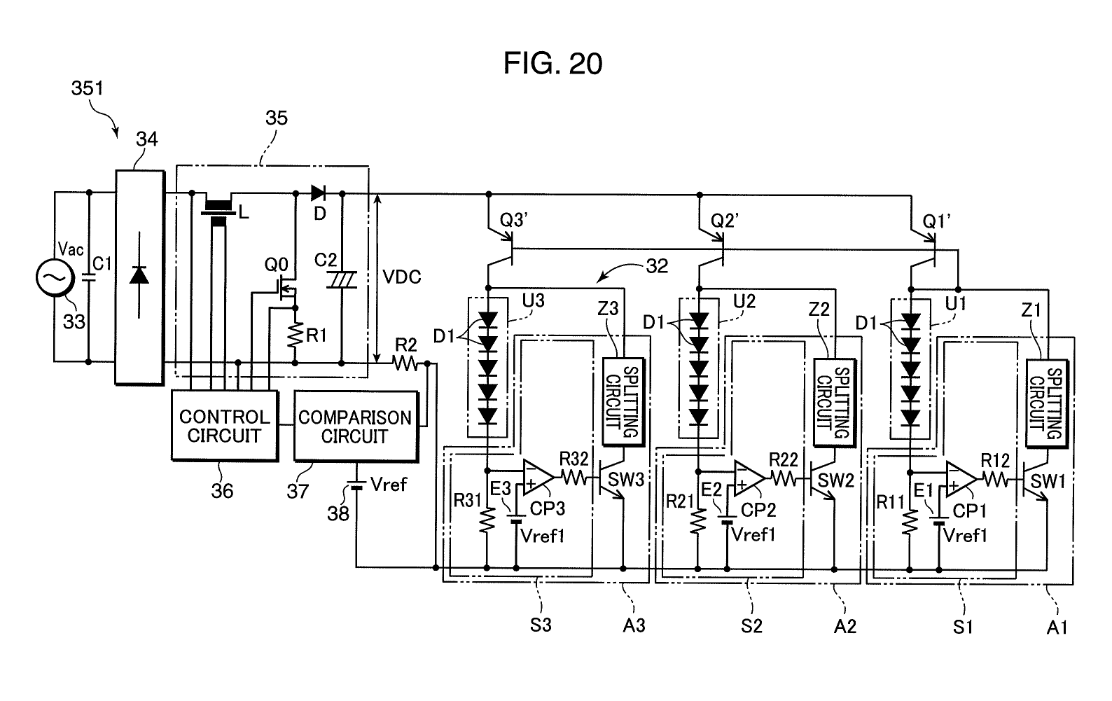

FIG. 20 is a block diagram showing a configuration of an LED lighting circuit 351 according to Embodiment 2 based on a fourth viewpoint of the present invention. In this LED lighting circuit 351, parts similar and corresponding to those of the aforementioned LED lighting circuit 331 are shown assigned the same reference numerals, and explanations thereof will be omitted. What should be noted is that in this LED lighting circuit 351, splitting circuits A1 to A3 are provided for respective LED load circuits U1 to U3 each made up of a plurality of serially connected LEDs D1.

For this purpose, the splitting circuits A1 to A3 are configured by including series circuits of impedance elements Z1 to Z3 and switch elements SW1 to SW3 arranged parallel to the respective LED load circuits U1 to U3 and wire breakage detection circuits S1 to S3 that detect the presence/absence of wire breakage of LEDs D1 in the respective LED load circuits U1 to U3, open the switch elements SW1 to SW3 in a normal condition and close the switch elements SW1 to SW3 when wire breakage is detected.

The wire breakage detection circuits S1 to S3 are configured by including current/voltage conversion resistors R11 to R31 arranged in series to the LED load circuits U1 to U3, comparators CP1 to CP3 that compare the inter-terminal voltage of the current/voltage conversion resistors R11 to R31 with a predetermined reference voltage Vref1, reference voltage sources E1 to E3 and base resistors R12 to R32 that connect the bases of the switch elements SW1 to SW3 made up of transistors and the output ends of the comparators CP1 to CP3.

Therefore, when there is no wire breakage in the LEDs D1 in the LED load circuit U1 to U3, a terminal voltage at a predetermined level is outputted from the current/voltage conversion resistor R11 to R31, which surpasses the reference voltage Vref1, causing the comparator CP1 to CP3 to output low level, whereby the switch element SW1 to SW3 is turned OFF and the impedance element Z1 to Z3 is separated from the LED load circuit U1 to U3. On the other hand, when wire breakage occurs, the terminal voltage of the current/voltage conversion resistor R11 to R31 becomes ground level, which is lower than the reference voltage Vref1, the comparator CP1 to CP3 outputs high level, causing the switch element SW1 to SW3 to turn ON and the impedance element Z1 to Z3 is connected between the output ends of the DC-DC converter 35 in series to the control elements Q1 to Q3 instead of the LED load circuits U1 to U3.

Such a configuration is especially suitably provided for each LED load circuit U1 to U3 made up of a plurality of series LEDs D1, making it possible to realize the splitting circuits A1 to A3 with small continuous loss and capable of bypassing currents upon detection of wire breakage.

### Embodiment 3 Based on Fourth Viewpoint

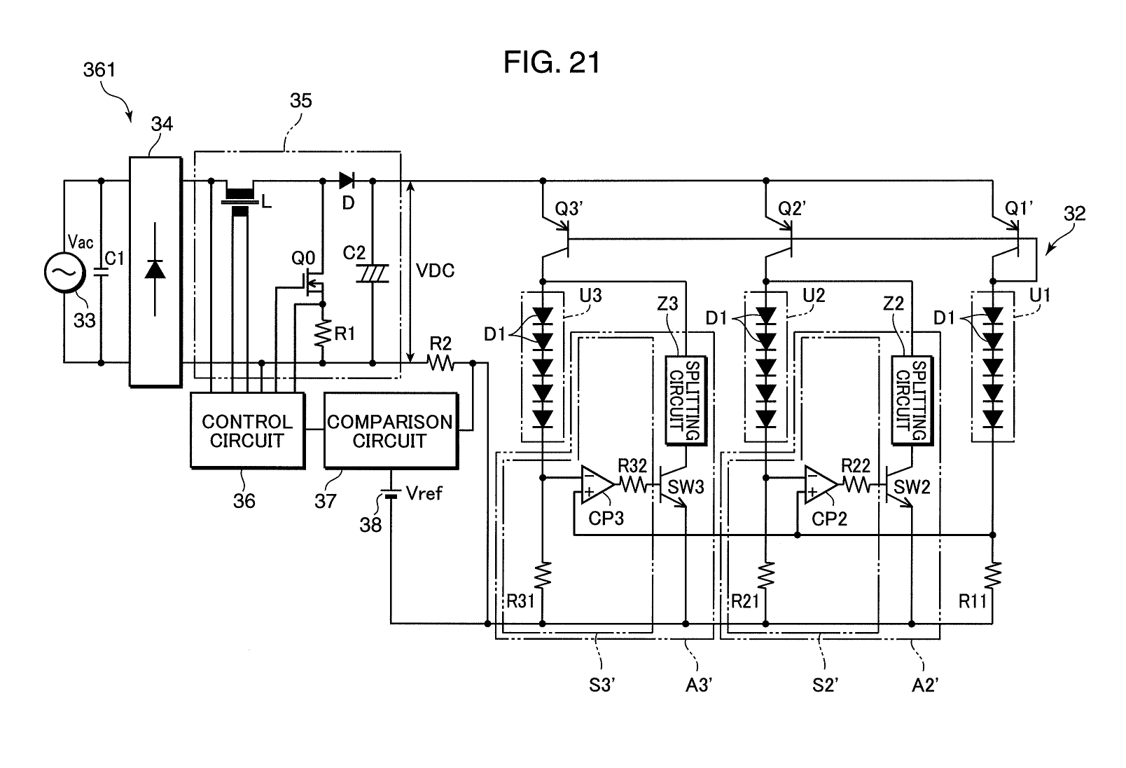

FIG. 21 is a block diagram showing a configuration of an LED lighting circuit 361 according to Embodiment 3 based on the fourth viewpoint of the present invention. In this LED lighting circuit 361, parts similar and corresponding to those in the aforementioned LED lighting circuit 351 are shown assigned the same reference numerals, and explanations thereof will be omitted. What should be noted is that in this LED lighting circuit 361, the LED load circuit U1 that creates a reference current of the current mirror circuit is provided with only the current/voltage conversion resistor R11 and not the splitting circuit A1, while in splitting circuits A2′ and A3′ of the remaining LED load circuits U2 and U3, the comparators CP2 and CP3 of wire breakage detection circuits S2′ and S3′ compare the inter-terminal voltage of the current/voltage conversion resistor R11 with the inter-terminal voltage of the current/voltage conversion resistors R21 and R31.

As described above, the LED load circuit U1 that creates a reference current of the current mirror circuit is a circuit with the highest sum of the ON voltages Vf of the LEDs D1, and therefore when wire breakage has not occurred in any LED, the terminal voltage of the current/voltage conversion resistor R11 inserted on the grounding side is lower than the terminal voltage of the remaining current/voltage conversion resistors R21 and R31 and the switch elements SW2 and SW3 remain OFF. On the contrary, when wire breakage occurs in the LED load circuit U2 or U3, the terminal voltage of the current/voltage conversion resistor R21 or R31 is lower than the terminal voltage of the current/voltage conversion resistor R11 and therefore the switch element SW2 or SW3 turns ON. Thus, it is possible to eliminate the reference voltage sources E2 and E3 for creating the reference voltage Vref1 and eliminate complicated adjustment of the reference voltage Vref1. When a short-circuit occurs in the LED load circuit U1 that creates a reference current of the current mirror circuit, all LEDs are turned OFF for the sake of safety.

### Summary of Fourth Viewpoint

As described above, the LED lighting circuit based on the fourth viewpoint of the present invention is an LED lighting circuit that causes a DC power supply to drive lighting of an LED module made up of a plurality of LED load circuits arranged parallel to each other, each LED load circuit being made up of one or a plurality of serially connected LEDs with a constant current, preferably including splitting circuits inserted parallel to one or a plurality of series LEDs between terminals thereof, which allow, in the event of wire breakage of an LED, a current at a level predefined for the LED to bypass the LED.

According to the above described configuration, in an LED lighting circuit to be used for an illuminating apparatus and the like, when a DC power supply drives lighting of an LED module made up of a plurality of LED load circuits arranged parallel to each other, each LED load circuit being made up of one or a plurality of serially connected LEDs with a constant current, splitting circuits are provided parallel to terminals of each LED or an arbitrary number of LEDs of an LED load circuit made up of a plurality of serially connected LEDs, each splitting circuit allows, in the event of wire breakage of the corresponding LED, a current at a level predefined for the LED to pass therethrough instead of the LED.

Therefore, the DC power supply collectively drives lighting of the LED module made up of a plurality of LEDs with a constant current and even if wire breakage occurs in an arbitrary LED, the current that should flow to the LED bypasses the wire breakage location and flows at the same level as before the wire breakage, makes it possible to prevent an overcurrent from flowing to the remaining LED load circuits, causing lighting up in an overloaded condition and prevent malfunctions from escalating into a chain reaction.

Furthermore, in the LED lighting circuit based on the fourth viewpoint of the present invention, the splitting circuit preferably includes a Zener diode.

According to the above described configuration, connecting a Zener diode or a series circuit of a Zener diode and a resistor parallel to the LEDs is especially suitable as a splitting circuit arranged for every one or a small number of LEDs, eliminates continuous loss and can bypass the current upon detection of wire breakage.

Furthermore, in the LED lighting circuit based on the fourth viewpoint of the present invention, the splitting circuit is preferably configured by including a series circuit of an impedance element and a switch element arranged parallel to the one or a plurality of series LEDs, and a wire breakage detection circuit that detects the presence/absence of wire breakage in the one or plurality of series LEDs, opens the switch element in a normal condition and closes the switch element when wire breakage is detected.

The above described configuration is especially suitable as a splitting circuit provided for each LED load circuit made up of a plurality of series LEDs, produces less continuous loss and can bypass currents upon detection of wire breakage.

Furthermore, in the LED lighting circuit based on the fourth viewpoint of the present invention, control elements are preferably arranged in series to the LED load circuits, the control elements configure a current mirror circuit and interlock flowing current value of each of the LED load circuits and one of the control elements corresponding to an LED load circuit with the highest voltage drop by LED currents including the sum of LED ON voltages in the corresponding LED load circuit is diode-connected so as to constitute a reference current circuit of the current mirror.

According to the above described configuration, control elements configuring a current mirror circuit are arranged in series to the LED load circuits to which constant currents are collectively flown from the DC power supply, a circuit with the highest voltage drop by LED currents including the sum of LED ON voltages Vf in the LED load circuits is used as a reference in the control elements, the control element corresponding to the LED load circuit is to have a diode structure and the flowing current values of the control elements of the remaining circuits are interlocked through control terminals and the LED load circuits are thereby balanced. To be more specific, when the control elements are transistors, the base and collector, which are control terminals, are short-circuited and the bases are connected commonly. On the other hand, when the control elements are MOS type transistors, the gate and drain, which are control terminals, are short-circuited and the gates are connected commonly.

Therefore, the current balance between the LED load circuits is uniformly controlled by the current mirror circuit, and so light outputs from many LEDs can be uniformized. Furthermore, since an LED load circuit with the highest sum of ON voltages Vf is used for the circuit that creates a reference current of the current mirror circuit, such a configuration does not require the circuit that creates only a reference current and can eliminate circuit loss accordingly.

Furthermore, in the LED lighting circuit based on the fourth viewpoint of the present invention, the DC power supply is a DC-DC converter and is preferably configured by including the current detection means for detecting a total value of currents flowing through the LED load circuits, a reference voltage source and a comparator that compare the detection results from the current detection means, and control means for controlling the DC power supply through feedback so that the sum of values of currents flowing to the LED module becomes a predetermined value according to the output from the comparator.

According to the above described configuration, the values of currents flowing from the DC power supply to the respective LED load circuits are detected and the DC power supply is subjected to constant current control through feedback based on the detection results so that the sum of the flowing current values becomes a predetermined value, and therefore losses at the control elements are smaller compared to constant voltage control and losses can be reduced.

Furthermore, the illuminating apparatus based on the fourth viewpoint of the present invention preferably uses the above described LED lighting circuit. According to the above described configuration, when the DC power supply collectively drives the LED module made up of a plurality of LEDs with a constant current, it is possible to realize an illuminating apparatus capable of preventing malfunctions from expanding in the event of wire breakage in the LEDs.

### Embodiment 1 Based on Fifth Viewpoint

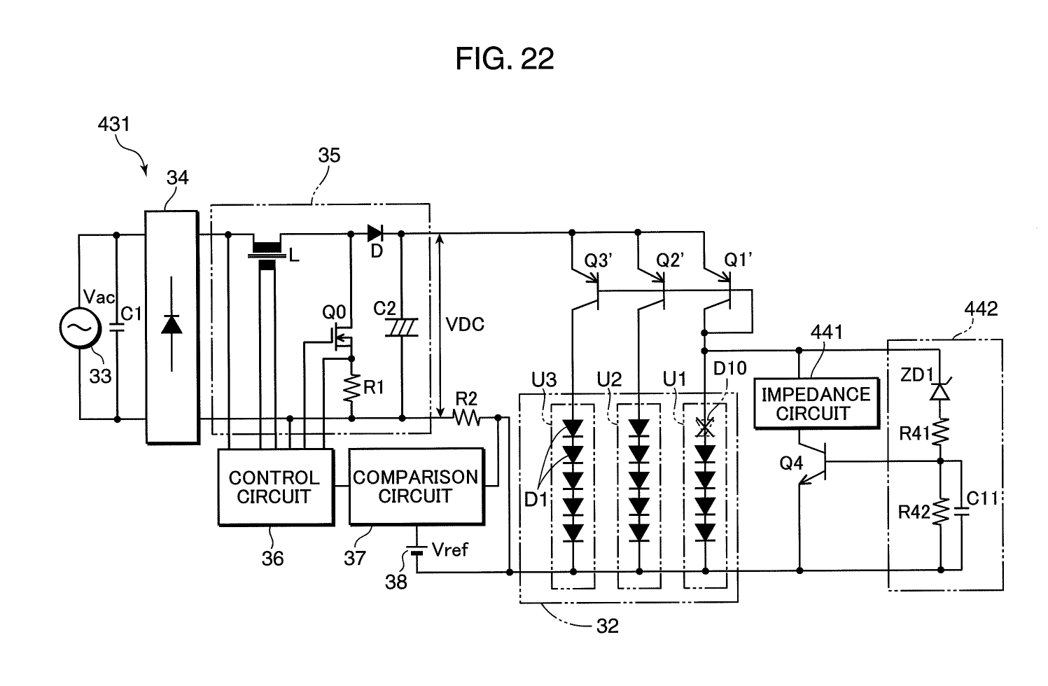

FIG. 22 is a block diagram showing a configuration of an LED lighting circuit 431 according to Embodiment 1 based on a fifth viewpoint of the present invention. In this LED lighting circuit 431, an LED module 32 is configured by connecting three LED load circuits U1 to U3 in parallel, each LED load circuit being made up of many serially connected LEDs D1. The number of series LED loads in each LED load circuit U1 to U3 is arbitrary and each LED load circuit may also be constructed of a single LED.

Each LED load circuit U1 to U3 is configured such that the LEDs D1 are mounted on and bonded to a common heat sink and a fluorescent substance for wavelength conversion and a light diffusion lens and the like are also attached. The LED module 32 and LED lighting circuit 431 are used as an illuminating apparatus, and emit blue or ultraviolet light as the LED load, convert, in wavelength, the light from the LED load using the fluorescent substance and emit the light as white light. The number of parallel circuits of the LED load circuits U1 to U3 is also arbitrary and a technique for obtaining white light by combining light emitted in three primary colors RGB, for example, is also arbitrary.

A DC voltage VDC resulting from converting a voltage Vac from a commercial power supply 33 to DC through a noise cut capacitor C1 and a rectification bridge 34 and converting the DC to a voltage via a DC-DC converter 35 is given to the LED module 32. The DC-DC converter 35 is constructed of a voltage boosting chopper circuit configured by including a switching element Q0 that switches the DC output voltage of the rectification bridge 34, a choke coil L that stores/discharges excitation energy through the switching, a diode D and a smoothing capacitor C2 that rectify and smooth the output current from the choke coil L, a resistor R1 that converts a current flowing through the switching element Q0 to a voltage for detection and a control circuit 36 that controls the switching of the switching element Q0.

The current that flows from the DC-DC converter 35, which is a DC power supply, to the LED module 32 is converted to a voltage value by a current detection resistor R2, compared with a reference voltage Vref from a reference voltage source 38 by a comparison circuit 37 and the comparison result is fed back to the control circuit 36. The control circuit 36 controls the switching frequency and duty of the switching element Q0 in response to the detection results of the resistors R1 and R2. Constant voltage control over the voltage VDC and constant current control over the current that flows to the LED module 32 are performed in this way.

What should be noted is that according to the present embodiment, in the respective LED load circuits U1 to U3, control elements Q1′ to Q3′ configuring a current mirror circuit are arranged in series to the LED load circuits U1 to U3 to equalize values of currents flowing through the LED load circuits U1 to U3, a circuit (U1 in the example of FIG. 22) with the highest voltage drop by LED currents including the sum of LED ON voltages Vf in the corresponding LED load circuits U1 to U3 in the control elements Q1′ to Q3′ is used as a reference and the control element (Q1′ in the example of FIG. 22) in the circuit is to have a diode structure, the flowing current values of the control elements (Q2′ and Q3′ in the example of FIG. 22) of the remaining circuits are interlocked through the control terminals and the LED load circuits U1 to U3 are thereby balanced.

To be more specific, when the control elements Q1′ to Q3′ are transistors as shown in FIG. 22, the base and collector, which are the control terminals, are short-circuited and the bases are commonly connected. On the other hand, when the control terminals are MOS type transistors, the gate and drain, which are the control terminals, are short-circuited and the gates are commonly connected.

What should be further noted is that an impedance circuit 441 is inserted parallel to the LED load circuit (U1 in the example of FIG. 22) which is the reference current circuit and the impedance circuit 441 bypasses the current that should flow through the LED load circuit U1 when wire breakage occurs in an LED D10 in the corresponding LED load circuit U1 and maintains the reference current of the current mirror circuit.

To be more specific, the impedance circuit 441 is constructed of elements or a circuit capable of generating a constant current such as a resistor, a constant current circuit, a Zener diode and a series circuit of a Zener diode and a resistor, and the like, with a switch element Q4 connected in series, and arranged parallel to the LED load circuit U1. Furthermore, a wire breakage detection circuit 442 is provided in connection with the LED load circuit U1 to detect wire breakage of the LEDs D10 in the circuit and cause the switch element Q4 to turn ON.

The wire breakage detection circuit 442 which is wire breakage detection means is intended to detect a terminal voltage of the LED load circuit U1, that is, a collector voltage of the control element Q1′, configured by including a series circuit of a Zener diode ZD1 and voltage dividing resistors R41 and R42 arranged parallel to the LED load circuit U1 and a capacitor C11 arranged parallel to the resistor R42, and the connection point among the voltage dividing resistor R41, voltage dividing resistor R42, and capacitor C11 is connected to the base of the switch element Q4 which is made up of a transistor. Due to wire breakage of some LED D10, when the terminal voltage of the LED load circuit U1, that is, the collector voltage of the control element Q1′ increases to a predetermined voltage which is higher than the sum of the LED ON voltages Vf, the Zener diode ZD1 turns ON and the switch element Q4 also turns ON and a current flows through the impedance circuit 441 instead of the LED load circuit U1 where the wire breakage has occurred. Therefore, the voltage dividing resistors R41 and R42 and capacitor C11 configure control means for controlling the switch element Q4 in response to the detection result of the Zener diode ZD1.

Configured as shown above, the sum of values of currents flowing from the DC-DC converter 35 to the LED load circuits U1 to U3 is controlled to be constant through collective constant current control based on the detection result of the resistor R2, and the current balance among the LED load circuits U1 to U3 is uniformly controlled through the current mirror circuit, and it is thereby possible to uniformize light outputs from many LEDs D1. Furthermore, since an LED load circuit with the highest sum of the ON voltages Vf of the LEDs D1 (U1 in the example of FIG. 22) is used for the circuit (Q1′ in the example of FIG. 22) that creates a reference current of the current mirror circuit, such a configuration does not require the circuit that creates only a reference current and can eliminate circuit loss accordingly. One of the control elements Q1′ to Q3′ made up of transistors and the like is to have a diode structure and only configured into a mirror circuit, and can thereby be realized in a low-cost configuration.

As in the case of the LED lighting circuit shown in the aforementioned conventional example in FIG. 29, the DC power supply of this LED lighting circuit 431 is a DC-DC converter 35 having the choke coil L, but may also be the insulation-type DC-DC converter having the transformer t shown in the conventional example in FIG. 30 and the DC power supply for the LED module 32 in particular is arbitrary. However, when constant current control through current mirror operation using the control elements Q1′ to Q3′ is performed, use of constant current control is preferable to use of constant voltage control for the DC power supply.

Furthermore, according to the present embodiment, even if wire breakage occurs in the LEDs D10 of the LED load circuit U1 which constitutes the reference current circuit, a reference current continues to flow through the impedance circuit 441, thus making it possible to prevent lighting out from extending to the other LED load circuits U2 and U3. Furthermore, with the switch element Q4 connected in series thereto, the impedance circuit 441 is arranged parallel to the LED load circuit U1 which constitutes a reference current circuit of the current mirror, and when wire breakage of some LED D10 is detected by the wire breakage detection circuit 442, the switch element Q4 turns ON, and the impedance circuit 441 is inserted, and it is thereby possible to suppress continuous loss by the impedance circuit 441, reduce power consumption and guard against wire breakage.

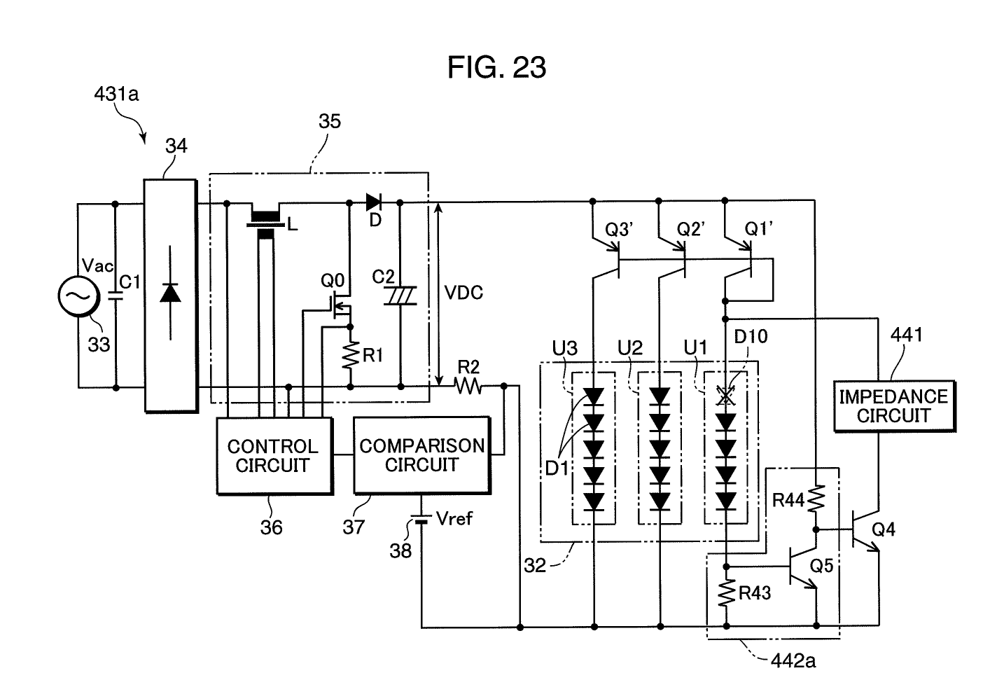

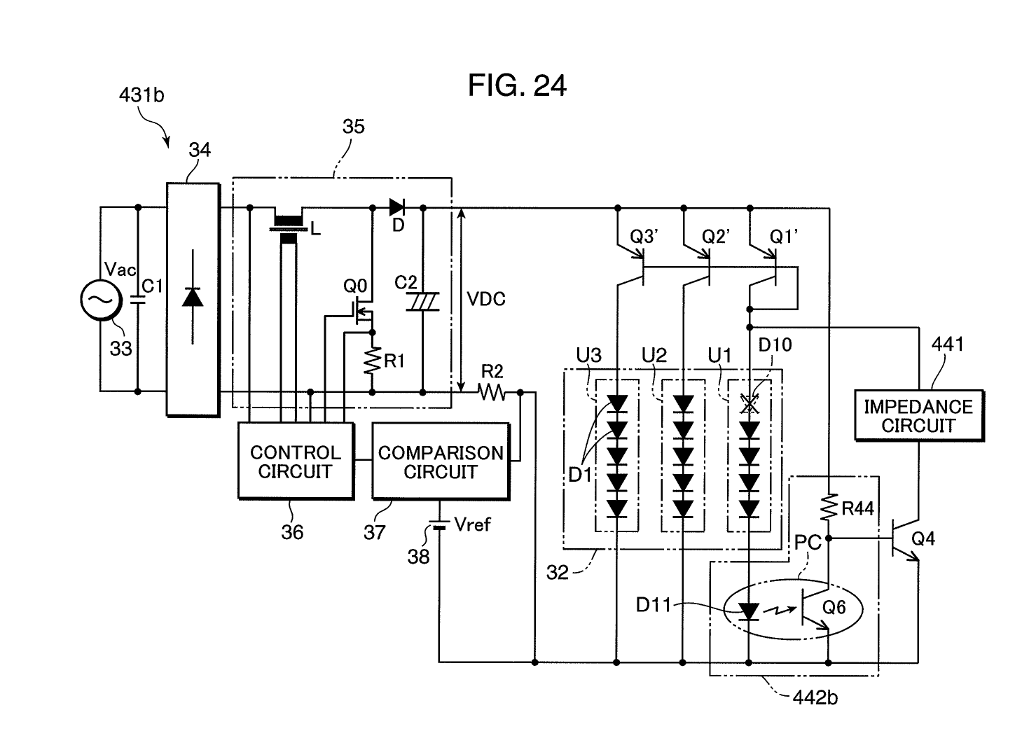

As other means of wire breakage detection by the wire breakage detection circuit 442, the Zener diode ZD1 may be replaced by a current/voltage conversion resistor R43 arranged in series to the LED load circuit U1 which constitutes the reference current circuit in an LED lighting circuit 431a shown in FIG. 23 or a light-emitting diode D11 in an LED lighting circuit 431b shown in FIG. 24 and so on.

To be more specific, in the wire breakage detection circuit 442a in FIG. 23, a resistor R44 and a control transistor Q5 are connected in series between the power supply lines, a voltage obtained from the current/voltage conversion resistor R43 is given to the base of the transistor Q5 and the output from the collector is given to the base of the switch element Q4. Therefore, while a current is flowing to the LED load circuit U1, the transistor Q5 is ON, the switch element Q4 is OFF and the impedance circuit 441 is separated. On the contrary, when a current no longer flows to the LED load circuit U1 due to wire breakage, the transistor Q5 turns OFF, the switch element Q4 turns ON and the impedance circuit 441 is inserted.

Likewise, in the wire breakage detection circuit 442b in FIG. 24, the resistor R44 and a control phototransistor Q6 are connected in series between the power supply lines and the phototransistor Q6 together with the light-emitting diode D11 constitutes a photocoupler PC and the output from the collector is given to the base of the switch element Q4. Therefore, while a current is flowing to the LED load circuit U1, the phototransistor Q6 is ON and the switch element Q4 is QFF and the impedance circuit 441 is separated. On the contrary, when a current no longer flows to the LED load circuit U1 due to wire breakage, the phototransistor Q6 turns OFF, the switch element Q4 turns ON and the impedance circuit 441 is inserted.

### Embodiment 2 Based on Fifth Viewpoint

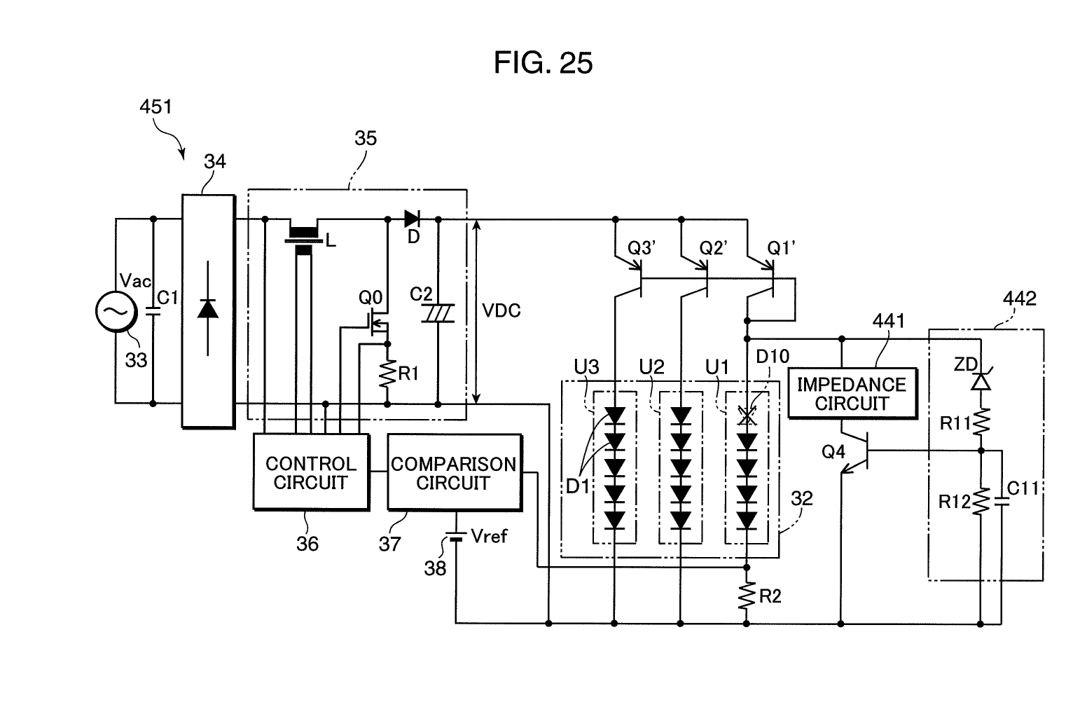

FIG. 25 is a block diagram showing a configuration of an LED lighting circuit 451 according to Embodiment 2 based on a fifth viewpoint of the present invention. In this LED lighting circuit 451, parts similar and corresponding to those of the aforementioned LED lighting circuit 431 are shown assigned the same reference numerals, and explanations thereof will be omitted. What should be noted is that in this LED lighting circuit 451, when a DC-DC converter 35 is subjected to constant current feedback control, a current detection resistor R2 thereof is inserted in the LED load circuit U1, which is the reference current creation circuit. In this case, loss at the resistor R2 can be reduced (in the example of FIG. 25, approximately ⅓ of loss in the example of FIG. 22). Furthermore, even if wire breakage occurs in LEDs D1 of any circuit other than the LED load circuit which becomes a reference, the remaining circuits can continue lighting with a constant current value.

### Embodiment 3 Based on Fifth Viewpoint

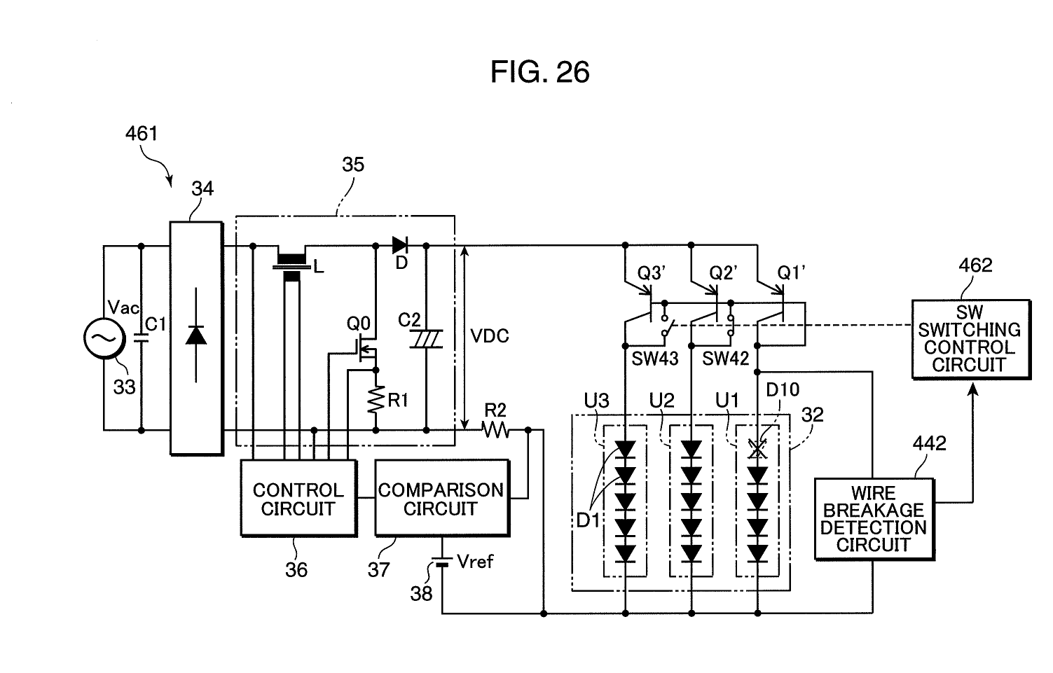

FIG. 26 is a block diagram showing a configuration of an LED lighting circuit 461 according to Embodiment 3 based on the fifth viewpoint of the present invention. In this LED lighting circuit 461, parts similar and corresponding to those in the aforementioned LED lighting circuit 431 are shown assigned the same reference numerals, and explanations thereof will be omitted. What should be noted is that in this LED lighting circuit 461, control elements Q2′ and Q3′ corresponding to the LED load circuits U2 and U3 other than the LED load circuit U1, which is the reference current creation circuit, are provided with switches SW42 and SW43 whereby, when the wire breakage detection circuit 442 detects wire breakage of the LED load circuit U1, which is the reference current creation circuit, the switch switching control circuit 462 can switch the corresponding control elements QT and Q3′ to a diode connection.

Therefore, in response to the occurrence of wire breakage, when the wire breakage detection circuit 442 turns ON one (SW42 in the example of FIG. 26) of the switches SW42 and SW43 which are short-circuit means, constant current operation continues to be performed by the LED load circuit (U2 in the example of FIG. 26) which has been turned ON and current balance with the remaining LED load circuit (U3 in the example of FIG. 26) is maintained. Thus, while lighting out is prevented from extending to other LED load circuits (U2 and U3 in the example of FIG. 26), the remaining LED load circuits continue lighting with uniform current values.

### Embodiment 4 Based on Fifth Viewpoint

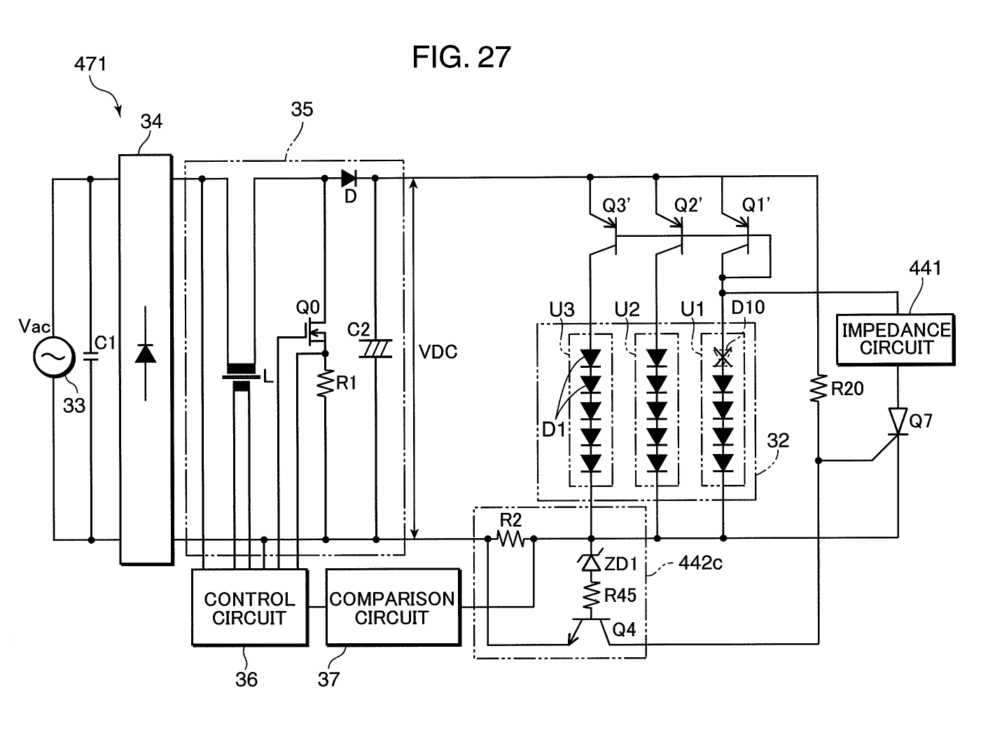

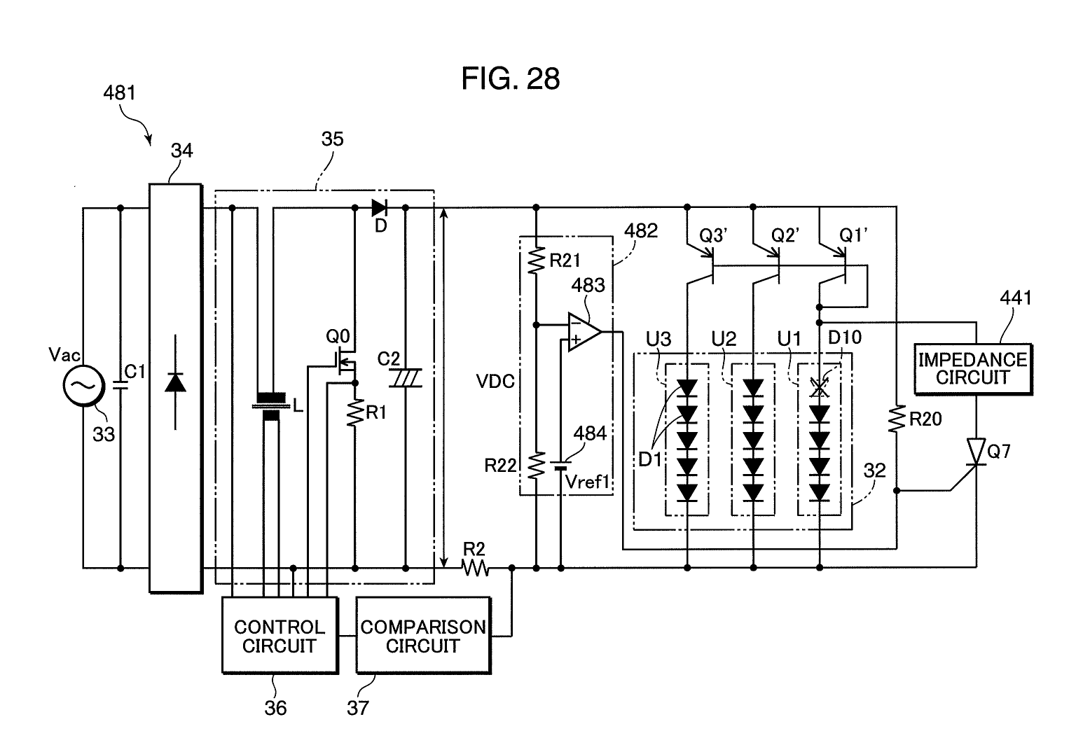

FIG. 27 and FIG. 28 are block diagrams showing configurations of LED lighting circuits 471 and 481 according to Embodiment 4 based on the fifth viewpoint of the present invention. In these LED lighting circuits 471 and 481, parts similar and corresponding to those of the aforementioned LED lighting circuit 431 are shown assigned the same reference numerals, and explanations thereof will be omitted. What should be noted is that in the LED lighting circuit 471 first, a wire breakage detection circuit 442c detects wire breakage of the LEDs D10 based on a reduction of the output current of a DC-DC converter 35. To be more specific, a thyristor Q7 is connected in series to the impedance element 441, the cathode of a Zener diode ZD1 is connected to the high side terminal of the current detection resistor R2 and the anode of the Zener diode ZD1 is connected to the base of a switch element Q4 from a resistor R45, the emitter of the switch element Q4 is connected to the low side terminal of the current detection resistor R2. Furthermore, the collector of the control element Q4 is connected to the gate of the thyristor Q7 via a bias resistor R20.

Therefore, when there is no wire breakage in the LEDs D10, the inter-terminal voltage of the current detection resistor R2 is high, the Zener diode ZD1 and switch element Q4 turn ON, the gate of the thyristor Q7 is driven low, the thyristor Q7 turns OFF, and the impedance circuit 441 is not inserted, and when wire breakage occurs in the LEDs D10, the terminal voltage of the current detection resistor R2 drops, the Zener diode ZD1 and the control element Q4 turn OFF, the gate of the thyristor Q7 is driven high, the thyristor Q7 turns ON and the impedance circuit 441 is inserted. Once the thyristor Q7 turns ON, the state thereof is maintained until the power supply is stopped. Therefore, the thyristor Q7 functions as latch means. The resistor R45 is provided so as to prevent the Zener diode ZD1 and the switch terminal Q4 from absorbing the voltage drop at the current detection resistor R2 for constant current feedback control.

On the other hand, in the LED lighting circuit 481, a wire breakage detection circuit 482 detects wire breakage of the LEDs D10 from an increase of the output voltage VDC of the DC-DC converter 35. To be more specific, the wire breakage detection circuit 482 is configured by including voltage dividing resistors R21 and R22 inserted between the output terminals of the DC-DC converter 35 and a comparator 483 and a reference voltage source 484 that compare a voltage at the connection point with a predetermined reference voltage Wref1, and the output of the comparator 483 is given to the gate of a thyristor Q7.

Therefore, when there is no wire breakage in the LEDs D10, the output voltage VDC becomes a defined voltage, the comparator 483 outputs low level, the thyristor Q7 turns OFF, the impedance circuit 441 is not inserted, and when wire breakage occurs in the LEDs D10, the output voltage VDC exceeds the defined voltage, the comparator 483 outputs high level, the thyristor Q7 turns ON and the impedance circuit 441 is inserted. Once the thyristor Q7 turns ON, the state is maintained until the power supply is stopped as in the case of FIG. 27.

Adopting such a configuration can also prevent full lighting out while suppressing continuous loss by the impedance circuit 441 even if wire breakage occurs in the LEDs D10 of the LED load circuit U1 which becomes a reference.

### Summary of Fifth Viewpoint

As described above, the LED lighting circuit based on the fifth viewpoint of the present invention is an LED lighting circuit that causes a current to flow from a DC power supply to an LED module made up of a plurality of LED load circuits arranged parallel to each other, each LED load circuit being made up of one or a plurality of serially connected LEDs, preferably including control elements arranged in series to the LED load circuits to configure a current mirror circuit and interlock flowing current values in the LED load circuits, one of which being to have a diode structure so that an LED load circuit with the highest voltage drop by LED currents including the sum of LED ON voltages in the LED load circuits becomes a reference current circuit of the current mirror and an impedance circuit arranged parallel to the LED load circuit which constitutes a reference current circuit of the current mirror that keeps a flowing current value to a reference current in the event of wire breakage of some LED in the LED load circuits.

According to the above described configuration, in an LED lighting circuit to be used for an illuminating apparatus, when a current is caused to flow from a DC power supply to an LED module made up of a plurality of LED load circuits arranged parallel to each other, each LED load circuit being made up of one or a plurality of serially connected LEDs, control elements configuring a current mirror circuit are arranged in series to the LED load circuits and a circuit with the highest voltage drop by LED currents including the sum of LED ON voltages Vf in the LED load circuits is used as a reference, the control element corresponding to the LED load circuit is to have a diode structure and flowing current values of the control elements of the remaining circuits are interlocked through control terminals and the LED load circuits are thereby balanced. To be more specific, when the control elements are transistors, the base and collector, which are control terminals, are short-circuited and the bases are connected commonly. On the other hand, when the control elements are MOS type transistors, the gate and drain, which are control terminals, are short-circuited and the gates are connected commonly. Furthermore, an impedance circuit is arranged parallel to the LED load circuit that constitutes the reference current circuit and when wire breakage occurs in LEDs in the corresponding LED load circuit, the impedance circuit bypasses the current that should flow through the LED load circuit and maintains the reference current of the current mirror circuit.

Therefore, since current balance between the LED load circuits is uniformly controlled by the current mirror circuit, light outputs from many LEDs can be uniformized. Furthermore, since the LED load circuit with the highest sum of the ON voltages Vf is used for the circuit that creates a reference current of the current mirror circuit, such a configuration does not require the circuit that creates only a reference current and can eliminate circuit loss accordingly. Furthermore, even if wire breakage occurs in the LEDs of the LED load circuit that constitutes the reference current circuit, the reference current continues to flow, thus preventing lighting out from extending to the other LED load circuits.

Furthermore, in the LED lighting circuit based on the fifth viewpoint of the present invention, the impedance circuit is preferably provided with a switch element connected in series thereto, is arranged parallel to the LED load circuit which constitutes the reference current circuit of the current mirror and further includes wire breakage detection means that detects wire breakage of the LEDs in connection with the LED load circuit which constitutes the reference current circuit of the current mirror and turns ON the switch element.

According to the above described configuration, wire breakage detection means is provided and the switch element is also arranged in series to the impedance circuit, and when wire breakage is detected, the switch element is turned ON and the impedance circuit is inserted.

The wire breakage detection means can be constructed of, for example, a Zener diode and control means for turning ON the switch element when an increase of the inter-terminal voltage of the LED load circuit due to wire breakage of the LED is equal to or greater than a Zener voltage of the Zener diode or constructed of current detection means such as a current detection resistor or light-emitting diode arranged in series to the LED load circuit that constitutes a reference current circuit of the current mirror, and control means such as a control transistor or phototransistor for turning ON the switch element when the current detection means detects interruption of current due to wire breakage of the LED.

Therefore, it is possible to suppress continuous loss by the impedance circuit, reduce power consumption and guard against wire breakage.

Furthermore, in the LED lighting circuit based on the fifth viewpoint of the present invention, the impedance circuit is preferably provided with a switch element connected in series thereto, arranged parallel to the LED load circuit that constitutes a reference current circuit of the current mirror and further includes wire breakage detection means for detecting wire breakage of the LED from an increase of the output voltage of the DC power supply or a decrease of the output current and latch means for keeping the switch element ON when wire breakage is detected by the wire breakage detection means.

According to the above described configuration, the wire breakage detection means and latch means are provided, the switch element is arranged in series to the impedance circuit, and once wire breakage is detected from an increase of the output voltage of the DC power supply or a decrease of the output current, the switch element is turned ON and the impedance circuit is inserted.

Therefore, it is possible to suppress continuous loss by the impedance circuit, reduce power consumption and guard against breakage.

Furthermore, the LED lighting circuit based on the fifth viewpoint of the present invention is an LED lighting circuit that causes a current to flow from a DC power supply to an LED module made up of a plurality of LED load circuits arranged parallel to each other, each LED load circuit being made up of one or a plurality of serially connected LEDs, preferably including control elements arranged in series to the LED load circuits to configure a current mirror circuit and interlock flowing current values in the LED load circuits, one of which is to have a diode structure so that an LED load circuit with the highest voltage drop by LED currents including the sum of LED ON voltages in the LED load circuits becomes a reference current circuit of the current mirror, wire breakage detection means arranged in connection with the LED load circuit which constitutes a reference current circuit of the current mirror for detecting wire breakage of LEDs in the LED load circuits and short-circuit means arranged in connection with the control elements corresponding to the LED load circuits other than the LED load circuit that constitutes the reference current circuit of the current mirror, that can switch one of the control elements to a diode connection when the wire breakage detection means detects wire breakage.

According to the above described configuration, in an LED lighting circuit to be used for an illuminating apparatus, when a current is caused to flow from a DC power supply to an LED module made up of a plurality of LED load circuits arranged parallel to each other, each LED load circuit being made up of one or a plurality of serially connected LEDs, control elements configuring a current mirror circuit are arranged in series to the LED load circuits and a circuit with the highest voltage drop by LED currents including the sum of LED ON voltages Vf in the LED load circuits is used as a reference, the control element in the circuit out of the control elements is to have a diode structure and flowing current values of the control elements of the remaining circuits are interlocked through control terminals and the LED load circuits are thereby balanced. To be more specific, when the control elements are transistors, the base and collector, which are control terminals, are short-circuited and the bases are connected commonly. On the other hand, when the control elements are MOS type transistors, the gate and drain, which are control terminals, are short-circuited and the gates are connected commonly. Furthermore, wire breakage detection means for detecting wire breakage of LEDs in the LED load circuit in connection with the LED load circuit which constitutes the reference current circuit is provided, short-circuit means that can short-circuit between the base and collector or between the gate and drain in connection with the control elements corresponding to the LED load circuits other than the LED load circuit that constitutes the reference current circuit of the current mirror is provided, and when the wire breakage detection means detects wire breakage, the short-circuit means switches one of the control elements to a diode connection.

Therefore, since current balance between the LED load circuits is uniformly controlled by the current mirror circuit, light outputs from many LEDs can be uniformized. Furthermore, since the LED load circuit with the highest sum of the ON voltages Vf is used for the circuit that creates a reference current of the current mirror circuit, such a configuration does not require the circuit that creates only a reference current and can eliminate circuit loss accordingly. Furthermore, when wire breakage occurs in some LED of the LED load circuit that constitutes the reference current circuit, one of the control elements corresponding to the other LED load circuits is diode-connected and continues to perform constant current operation, thus preventing lighting out from extending to the other LED load circuits.

Furthermore, in the LED lighting circuit based on the fifth viewpoint of the present invention, the DC power supply is a DC-DC converter and preferably includes current detection means for detecting a total value of currents flowing through the LED load circuits or a value of current flowing through the LED load circuit corresponding to the diode-connected control element, a reference voltage source and a comparator for comparing the detection results from the current detection means and control means for controlling the DC power supply through feedback according to the output from the comparator so that the sum of values of currents flowing to the LED module becomes a predetermined value.

According to the above described configuration, value of currents flowing from the DC power supply to the respective LED load circuits is detected and the DC power supply is subjected to constant current control through feedback based on the detection result so that the sum of the flowing current values becomes a predetermined value, and therefore loss at the control elements is smaller compared to constant voltage control and loss can be reduced.

Furthermore, the illuminating apparatus based on the fifth viewpoint of the present invention preferably uses the above described LED lighting circuit.

According to the above described configuration, it is possible to uniformize light outputs from many LEDs and realize a low-loss illuminating apparatus.

Parts in the present description described as means for realizing certain functions are not limited to the configurations described in the description for realizing those functions, and units and parts and the like for realizing those functions are also included therein.

### INDUSTRIAL APPLICABILITY

The present invention can provide an LED lighting circuit capable of uniformizing light outputs from many LEDs.

1. An LED lighting circuit that causes a current to flow from a DC power supply to an LED module comprising a plurality of LEDs arranged parallel to each other, comprising control elements arranged in series to the LED respective circuits configuring a current mirror circuit,
wherein a circuit with a highest voltage drop by LED currents including ON voltages of the LEDs is used as a reference, the control element in the circuit is to have a diode structure and flowing current values of the control elements of the remaining circuits are interlocked through control terminals of the control element.

2. The LED lighting circuit according to claim 1 that causes a current to flow from a DC power supply to an LED module comprising a plurality of LED load circuits arranged parallel to each other, each LED load circuit comprising one or a plurality of serially connected LEDs, comprising control elements arranged in series to the respective LED load circuits configuring a current mirror circuit,
wherein a circuit with a highest voltage drop by LED currents including the sum of the LED ON voltages in the LED load circuits is used as a reference, the control element in the circuit is to have a diode structure and the flowing current values of the control elements of the remaining circuits are interlocked through control terminals of the control element.

3. The LED lighting circuit according to claim 1 that causes a current to flow from a DC power supply to an LED module comprising a plurality of LEDs,
wherein the LED module comprises a plurality of LED load circuits connected in series, each LED load circuit comprising a plurality of LEDs connected parallel to each other and each of the LEDs comprises control elements configuring a current minor circuit arranged in series, and
an LED with the highest ON voltage in the respective LED load circuits is used as a reference, the control element corresponding to the LED is to have a diode structure and the flowing current values of the control elements of the remaining LEDs in the LED load circuits are interlocked through control terminals.

4. The LED lighting circuit according to claim 2, wherein the DC power supply is a DC-DC converter comprising:
a current detector for collectively detecting currents flowing through the LED module;
a reference voltage source and a comparator for comparing the detection result from the current detector; and
a controller for controlling the DC power supply through feedback so that the sum of values of currents flowing to the LED module becomes a predetermined value according to the output from the comparator.

5. The LED lighting circuit according to claim 2, further comprising a configuration that detects a value of current flowing from the DC power supply to the LED module and controls the DC power supply through feedback based on the detection result so that the flowing current value becomes a predetermined value,
wherein a current detector for detecting the flowing current value is inserted in the reference circuit.

6. The LED lighting circuit according to claim 5, wherein the DC power supply is a DC-DC converter comprising:
a reference voltage source and a comparator for comparing the detection result from the current detector; and
a controller for controlling the DC power supply so that the value of current flowing to the LED module becomes a predetermined value according to the output from the comparator.

7. The LED lighting circuit according to claim 1 that causes a current to flow from a DC power supply to an LED module comprising a plurality of LED load circuits arranged parallel to each other, each LED load circuit comprising one or a plurality of serially connected LEDs, comprising:
control elements arranged in series to the respective LED load circuits to configure a current mirror circuit and interlock flowing current values in the LED load circuits, one of which is to have a diode structure so as to constitute a reference current circuit of the current mirror; and
an impedance element inserted in series to the circuit of the control element having the diode structure that produces a voltage drop equal to or greater than Vf×n×σ at a rated current where Vf is an ON voltage of the LED, σ is a variance and n is the number of serially connected LEDs.

8. (canceled)

9. The LED lighting circuit according to claim 7, further comprising:
a short-circuit switch that can short-circuit between terminals of the impedance element;
a detector for detecting a sum of LED ON voltages Vf in the respective LED load circuits while the short-circuit switch is opened and the control element is performing current mirror operation; and
a switching controller for responding to the detection result of the detector, closing the short-circuit switch when the sum of ON voltages Vf of the LED load circuit whose control element has the diode structure is highest and opening the short-circuit switch otherwise.

10. The LED lighting circuit according to claim 1 that causes a current to flow from a DC power supply to an LED module comprising a plurality of LED load circuits arranged parallel to each other, each LED load circuit comprising one or a plurality of serially connected LEDs, comprising:
control elements arranged in series to the respective LED load circuits, configuring a current mirror circuit so as to interlock flowing current values in the LED load circuits, one of which is to have a diode structure so as to constitute a reference current circuit of the current mirror; and
an impedance element inserted parallel to circuits other than the circuit with the control element of the diode structure that reduces impedance of the LED load circuit.

11. The LED lighting circuit according to claim 7, wherein the DC power supply is a DC-DC converter comprising:
a current detector for detecting a total value of currents flowing through the LED load circuits or a value of current flowing through the LED load circuit corresponding to the diode-connected control element;
a reference voltage source and a comparator for comparing the detection result from the current detector; and
a controller for controlling the DC power supply through feedback so that the sum of values of currents flowing to the LED module becomes a predetermined value according to the output from the comparator.

12. The LED lighting circuit according to claim 1 that causes a DC power supply to drive lighting of an LED module comprising a plurality of LED load circuits arranged parallel to each other, each LED load circuit comprising one or a plurality of serially connected LEDs with a constant current, comprising splitting circuits inserted parallel to one or a plurality of series LEDs between terminals thereof that allow, in the event of wire breakage of an LED, a current at a level predefined for the LED to bypass the LED.

13. (canceled)

14. The LED lighting circuit according to claim 12, wherein the splitting circuit comprises a series circuit of an impedance element and a switch element arranged parallel to the one or plurality of series LEDs and a wire breakage detection circuit that detects the presence/absence of wire breakage in the one or plurality of series LEDs, opens the switch element in a normal condition and closes the switch element when wire breakage is detected.

15. The LED lighting circuit according to claim 12, wherein the respective LED load circuits comprise control elements in series, the control elements configure a current mirror circuit to interlock flowing current values of the respective LED load circuits and a control element corresponding to an LED load circuit with a highest voltage drop by LED currents including the sum of LED ON voltages in the corresponding LED load circuit out of the control elements is to have a diode connection so as to constitute a reference current circuit of the current mirror.

16. The LED lighting circuit according to claim 12, wherein the DC power supply is a DC-DC converter comprising:
a current detector for detecting a total value of currents flowing through the LED load circuits;
a reference voltage source and a comparator for comparing the detection results from the current detector; and
a controller for controlling the DC power supply through feedback so that the sum of values of currents flowing to the LED module becomes a predetermined value according to the output from the comparator.

17. The LED lighting circuit according to claim 2, further comprising an impedance circuit arranged parallel to the LED load circuit that constitutes a reference current circuit of the current mirror that keeps, in the event of wire breakage of an LED in the LED load circuit, the flowing current value to a reference current.

18. The LED lighting circuit according to claim 17, wherein the impedance circuit comprises a switch element connected in series thereto, is arranged parallel to the LED load circuit which constitutes the reference current circuit of the current mirror, and
further comprises a wire breakage detector for detecting wire breakage of the LEDs in connection with the LED load circuit which constitutes the reference current circuit of the current mirror and causing the switch element to turn ON.

19. The LED lighting circuit according to claim 18, wherein the wire breakage detector comprises a Zener diode and a controller for causing the switch element to turn ON when an increase of an inter-terminal voltage of the LED load circuit due to wire breakage of the LED is equal to or greater than a Zener voltage of the Zener diode.

20. The LED lighting circuit according to claim 18, wherein the wire breakage detector comprises a current detector arranged in series to the LED load circuit which constitutes a reference current circuit of the current mirror and a controller for causing the switch element to turn ON when the current detector detects interruption of current due to wire breakage of the LED.

21. The LED lighting circuit according to claim 17, wherein the impedance circuit comprises a switch element connected in series thereto, is arranged parallel to the LED load circuit that constitutes a reference current circuit of the current mirror, and
further comprises a wire breakage detector for detecting wire breakage of the LED from an increase of the output voltage of the DC power supply or a decrease of the output current and a latch for keeping the switch element ON when wire breakage is detected by the wire breakage detector.

22. The LED lighting circuit according to claim 2, further comprising:
a wire breakage detector arranged in connection with an LED load circuit which constitutes a reference current circuit of the current mirror for detecting wire breakage of LEDs in the LED load circuit; and
a short-circuiter arranged in connection with control elements corresponding to LED load circuits other than the LED load circuit which constitutes a reference current circuit of the current mirror that can switch, when the wire breakage detector detects wire breakage, one of the control elements to a diode connection.

23. The LED lighting circuit according to claim 17, wherein the DC power supply is a DC-DC converter comprising:
a current detector for detecting a total values of currents flowing through the LED load circuits or a value of current flowing through the LED load circuit corresponding to the diode-connected control element;
a reference voltage source and a comparator for comparing the detection results from the current detector; and
a controller for controlling the DC power supply through feedback according to the output from the comparator so that the sum of values of currents flowing to the LED module becomes a predetermined value.

24. (canceled)

25. The LED lighting circuit according to claim 3, wherein the DC power supply is a DC-DC converter comprising:
a current detector for collectively detecting currents flowing through the LED module;
a reference voltage source and a comparator for comparing the detection result from the current detector; and
a controller for controlling the DC power supply through feedback so that the sum of values of currents flowing to the LED module becomes a predetermined value according to the output from the comparator.

26. The LED lighting circuit according to claim 10, wherein the DC power supply is a DC-DC converter comprising:
a current detector for detecting a total value of currents flowing through the LED load circuits or a value of current flowing through the LED load circuit corresponding to the diode-connected control element;
a reference voltage source and a comparator for comparing the detection result from the current detector; and
a controller for controlling the DC power supply through feedback so that the sum of values of currents flowing to the LED module becomes a predetermined value according to the output from the comparator.

27. The LED lighting circuit according to claim 22, wherein the DC power supply is a DC-DC converter comprising:
a current detector for detecting a total values of currents flowing through the LED load circuits or a value of current flowing through the LED load circuit corresponding to the diode-connected control element;
a reference voltage source and a comparator for comparing the detection results from the current detector; and
a controller for controlling the DC power supply through feedback according to the output from the comparator so that the sum of values of currents flowing to the LED module becomes a predetermined value.
